(19) United States
(12) Patent Application Publication
(10) Pub. No.: US 2004/0024721 A1
(43) Pub. Date: Feb. 5, 2004

(54) Adaptive decision engine

(76) Inventors: Michael Thomas Wilfrid Donovan, Montreal (CA); Sylvio Drouin, Montreal (CA)

Correspondence Address: OGILVY RENAULT, 1981 MCGILL COLLEGE AVENUE, SUITE 1600, MONTREAL, QC, H3A2Y3, CA

(21) Appl. No.: 10/387,133

(22) Filed: Mar. 13, 2003

Related U.S. Application Data
(60) Provisional application No. 60/364,088, filed on Mar. 15, 2002.
(60) Provisional application No. 60/433,855, filed on Dec. 17, 2002.

(51) Int. Cl. G06F 17/00; G06N 5/02; G06F 15/18

(52) U.S. Cl. 706/46; 706/14

(57) ABSTRACT

The present invention relates to an apparatus for selecting actions in an environment, comprising: a first store comprising a plurality of proposed series of actions; an environment interface providing at least one action to an environment and detecting at least one state value from the environment resulting, at least in part, from the action provided; an evaluation module calculating a global desirability value for an unvalued series of actions of the plurality according to the state value and storing the desirability value in the store; and a selection module for selecting one of the plurality according to the desirability value, and providing at least a first action of the selected series to the environment interface.

The present application claims priority of US provisional patent application 60/364,088 filed Mar. 15, 2002, and US provisional patent application 60/433,855 filed Dec. 17, 2002.

### BACKGROUND OF THE INVENTION

(a) Field of the Invention

This invention relates to an artificial intelligence decision engine that combines planning and forecasting.

(b) Description of Prior Art

The promise of Artificial Intelligence (AI), let alone autonomous computing, extends considerably beyond the current state of the art. One of the most prominent themes in AI, decision theory, has been particularly deceitful: its algorithms provide satisfactory results within their domain of application, but fail to do so otherwise due to their level of specialization.

The RTA* algorithm is well known in the art, and is mostly applied to computer games, where programs must commit to irrevocable moves due to time constraints. An implementation of this algorithm commits to a single real-world action at the end of every time frame. Every time the selected action is carried out, the algorithm restarts its search from the newly reached state. Another embodiment is configured to commit to more than one real-world action at the end of every frame, where the length of a frame would depend on the depth of a pre-established search horizon. Both implementations make progress towards goals without planning a complete sequence of solution steps in advance, thereby providing the flexibility and fault-tolerance required by dynamically evolving environments. However, they are incapable of looking ahead, as they only optimize one action at a time. Furthermore, their exponential complexity considerably restricts the size of problems they can realistically solve. Finally, they do not autonomously adapt themselves to evolving dynamic environments.

Dynamic Bayesian Network (DBN) algorithms use probability theory to manage uncertainty by explicitly representing conditional dependencies between different knowledge components. Known for their inference capabilities under conditions of uncertainty, such algorithms are frequently implemented to provide support for decision engines, such as the one illustrated in FIG. 1. Such engines provide planning by deriving sequences of actions from sequences of state probabilities. However, they do not handle large solution spaces, as they map actions from forecasted sates. Other implementations use a DBN to explicitly select decisions to be taken; such engines do not handle large solution spaces, and are unable to efficiently deal with changes of goals. Indeed, once the network is trained to achieve a certain goal, its internal variables are set accordingly. Therefore, a new goal would require further training in order for the network to adjust its internal variables accordingly. Finally, the engine presented in FIG. 1 and variants thereof are unable to autonomously evolve their decisions in order to converge towards a goal.

Other engines such as the one illustrated in FIG. 2 rely on genetic algorithms and are known in the art for their ability to handle large, if not infinite, solution spaces. They converge towards solutions by evolving a population of well-adapted string entities; in every generation, a new offspring is created using the fittest strings as progenitors and, occasionally, modifications are performed to explore new venues and further the evolution process. Such algorithms are applied to decision engines, where string entities represent sequences of actions. However, they are not able to adapt their evaluation process when decisions yield unexpected results. Furthermore, they are unable to exploit their experience in order to accelerate their convergence towards a goal. Finally, such engines need to have a complete understanding of the environment in which they operate and the results of their actions in order to evaluate the desirability of their actions. Therefore, they are unable to operate efficiently in complex dynamic environments.

Finally, decision engines such as the one illustrated in FIG. 3 are capable of autonomous learning in a real-world environment, and are known in the art. They are typically implemented as case-based reasoning systems coupled to sensors for gathering information from, and to effectors for manipulating their environment. Their evaluation process is adaptive according to reinforcement values provided by the environment. Moreover, they comprise an experimenter to explore new venues. Such an engine is disclosed in U.S. Pat. No. 5,586,218, issued on Dec. 17, 1996 to Allen. However, such agents do not forecast states that would result from their actions, and are therefore very limited in terms of their ability to evaluate their options prior to making a decision. Furthermore, they do not handle new goals in an efficient manner, as they need to undergo supervised training in order to adapt their evaluation process accordingly.

### SUMMARY OF THE INVENTION

It would be desirable to be provided with a decision engine that is capable of forecasting an intermediate state parameter values that would be detected if a series of actions were performed, and evaluating a desirability of the series of actions according to the intermediate state parameter value.

It would be desirable to be provided with a decision engine capable of converging towards a goal more efficiently in a dynamically evolving environment than prior art, whereby a lesser number of decisions would need to be made.

It would also be desirable to be provided with a flexible, fault-tolerant decision engine capable of handling larger solution spaces than prior art.

It would also be desirable to be provided with a decision engine capable of handling large solution spaces that is more flexible and fault-tolerant than prior art.

The decision engine of the present invention is designed to lead a slave-application towards achieving a user-defined goal in a user-defined environment. Once the goal of the engine and the environment are defined, the engine generates a plurality of series of actions, each of which represents a plausible scenario. Subsequently, for each action comprised in a generated scenario, the engine forecasts a state that would be reached by performing the action in a state that would result from performing all previous actions comprised in the scenario. The forecasted states are thereafter analyzed in order to attribute desirability values to generated scenarios. Once a decision is to be taken, the engine provides at least a first action of a best series of actions selected according to desirability values. The same action is used to filter the pool, as the engine deletes all scenarios starting with an action different from the one selected or having a lower desirability than a predetermined threshold, and discards the first action of the remaining scenarios. The process is executed iteratively until the engine reaches its goal.

In accordance with the present invention, there is provided an apparatus for selecting actions in an environment, comprising: a first store comprising a plurality of proposed series of actions; an environment interface providing at least one action to an environment and detecting at least one state value from the environment resulting, at least in part, from the action provided; an evaluation module calculating a global desirability value for an unvalued series of actions of the plurality according to the state value and storing the desirability value in the store; and a selection module for selecting one of the plurality according to the desirability value, and providing at least a first action of the selected series to the environment interface.

In accordance with one preferred embodiment of the present invention, the apparatus further comprises one forecasting module for forecasting at least one state value that would be detected from the environment between a first moment at which a first action of the unvalued series would be provided to the environment and a second moment at which a last action of the unvalued series would be provided to the environment if each action of the unvalued series is provided to the environment, wherein the evaluation module calculates a global desirability value for the unvalued series according to the state value forecasted and stores the desirability value in the store.

In accordance with one preferred embodiment of the present invention, the apparatus further comprises an adjustable timer for synchronizing an activity of the evaluation module, the forecasting module, and the selection module according to a rate at which decisions are expected from the apparatus.

In accordance with one preferred embodiment of the invention, the apparatus further comprises a filter module deleting each one of the plurality of proposed series of actions that do not start with the at least one action, and removing at least a first action of proposed series of actions remaining in the store to provide a filtered plurality of proposed series of actions.

In accordance with one preferred embodiment of the present invention, the apparatus further comprises an adjustable timer for synchronizing an activity of the evaluation module, and the selection module according to a rate at which decisions are expected from the apparatus.

In accordance with one preferred embodiment of the present invention, the timer further comprises a regulator for determining the rate according to the state value detected.

In accordance with one preferred embodiment of the present invention, the filter module deletes each one of the plurality of proposed series of actions that do not start with the at least one action, deletes each one of the plurality of proposed series of actions having a global desirability value lower than a filtering threshold, and removes at least a first action of proposed series of actions remaining in the store to provide a filtered plurality of proposed series of actions.

In accordance with one preferred embodiment of the present invention, the filter module further comprises a threshold calculator for calculating the filtering threshold.

In accordance with one preferred embodiment of the present invention, the filtering threshold is an average global desirability value of all possible series of actions starting with the at least one action.

In accordance with one preferred embodiment of the present invention, the apparatus further comprises a search module for generating a new plurality of proposed series of actions, and storing the new plurality in the store.

In accordance with one preferred embodiment of the present invention, the apparatus further comprises a second store comprising a plurality of actions, wherein the search module generates at least one of the new pluralities from the plurality of actions.

In accordance with one preferred embodiment of the present invention, the search module comprises a genetic module for generating at least one of the new pluralities by applying a genetic operator on one of the plurality of proposed series of actions.

In accordance with one preferred embodiment of the present invention, the selection module comprises a saturation detector for determining whether the first store is saturated, in which case the selection module identifies a least desirable proposed series of actions comprised in the first store according to the desirability value, and deletes the least desirable.

In accordance with one preferred embodiment of the present invention, the apparatus further comprises an input module for detecting an instruction, determining an evaluation parameter value according to the instruction, and setting the parameter value, wherein the evaluation module calculates the desirability value according to the parameter value.

In accordance with one preferred embodiment of the present invention, the input module comprises a translation module for translating the instruction into the parameter value.

In accordance with one preferred embodiment of the present invention, the input module comprises a regulator for determining the rate according to the instruction.

In accordance with one preferred embodiment of the present invention, the input module comprises a regulator for determining the rate according to the instruction.

In accordance with one preferred embodiment of the present invention, the apparatus further comprises a third store comprising a series of previously selected actions and a series of previously detected state values, wherein the genetic module generates at least one of the new plurality by applying a genetic operation on a series of actions extracted from the series of previously selected actions.

In accordance with one preferred embodiment of the present invention, the apparatus further comprises a fourth store comprising a plurality of patterns, wherein the forecasting module forecasts the at least one state value that would be detected from the environment according to one of the plurality of patterns.

In accordance with on preferred embodiment of the present invention, the apparatus further comprises a fourth store comprising a plurality of patterns associated with a plurality of environments, wherein the input module determines the environment according to the instruction, the plurality of environments comprises the environment, and the forecasting module forecasts the at least one state value according to one of the plurality of patterns associated with the environment, whereby the forecasting module is capable of adjusting its functionality according to the environment.

In accordance with on preferred embodiment of the present invention, the forecasting module further comprises a pattern-recognizer for identifying at least one pattern in the series of previously selected actions and the series of previously detected state values, and storing the pattern in the fourth store.

In accordance with one preferred embodiment of the present invention, the pattern-recognizer is a neural network comprising a plurality of input nodes for receiving at least one current state value and at least one action, and at least one output node for forecasting the at least one state value that would be detected from the environment.

In accordance with one preferred embodiment of the present invention, the apparatus further comprises a store of rules comprising a set of requirements to be satisfied by the new plurality, wherein the search module generates the new plurality according to the requirements, whereby the new plurality is more likely to have a higher desirability.

In accordance with one preferred embodiment of the present invention, the at least one evaluation module comprises a local calculator for calculating local desirability values for actions comprised in the unvalued series of actions according to the at least one state value forecasted, and a global calculator for calculating a global desirability value from the local desirability values.

In accordance with one preferred embodiment of the present invention, the evaluation module comprises a local calculator for calculating local desirability values for actions comprised in the unvalued series of actions, and a global calculator for calculating a global desirability value from the local desirability values.

In accordance with one preferred embodiment of the present invention, the global calculator attributes more weight to local desirability values for actions located at endings of series of actions, whereby the apparatus is adapted to select actions to achieve a long-term goal.

In accordance with the present invention, there is provided a computer program product for selecting actions in an environment comprising a computer usable storage medium having computer readable program code means embodied in the medium, the computer readable program code means comprising: storage means for providing a plurality of proposed series of actions; interfacing means for providing at least one action to the environment and detecting at least one state value from the environment resulting, at least in part, from the action provided; evaluation means for calculating a global desirability value for an unvalued series of actions of the plurality according to the state value and providing the desirability value; and selection means for selecting one of the plurality according to the global desirability value, and identifying at least a first action of the selected series of actions as the at least one action.

In accordance with one preferred embodiment of the present invention, the computer program product further comprises forecasting means for forecasting at least one state value that would be detected from the environment between a first moment at which a first action of the unvalued series would be provided to the environment and a second moment at which a last action of the unvalued series would be provided to the environment if each action of the unvalued series is provided to the environment, wherein the evaluation means comprises means for calculating a global desirability value for the unvalued series according to the state value forecasted.

In accordance with one preferred embodiment of the present invention, the computer program product further comprises synchronization means for synchronizing an execution of the evaluation means, the forecasting means, and the selection means according to a rate at which decisions are expected from the product.

In accordance with one preferred embodiment of the present invention, the computer program product further comprising filtering means for deleting each one of the plurality of proposed series that do not start with the at least one action, and removing at least a first action of proposed series of actions remaining to provide a filtered plurality of proposed series of actions.

In accordance with one preferred embodiment of the present invention, the computer program product further comprises synchronization means for synchronizing an execution of the evaluation means, and the selection means according to a rate at which decisions are expected from the product.

In accordance with one preferred embodiment of the present invention, the synchronization means further comprises means for determining the rate according to the state value detected.

In accordance with one preferred embodiment of the present invention, the computer program product further comprising filtering means for deleting each one of the plurality of proposed series that do not start with the at least one action, deleting each one of the plurality of proposed series having a desirability value lower than a filtering threshold, and removing at least a first action of proposed series of actions remaining to provide a filtered plurality of proposed series of actions.

In accordance with one preferred embodiment of the present invention, the computer program product wherein the filtering means comprises means for calculating the filtering threshold.

In accordance with one preferred embodiment of the present invention, the filtering threshold is an average global desirability value of all possible series of actions starting with the at least one action.

In accordance with one preferred embodiment of the present invention, the computer program product further comprises searching means for generating a new plurality of proposed series of actions.

In accordance with one preferred embodiment of the present invention, the computer program product further comprising means for providing a plurality of actions, wherein the searching means generates at least one of the new plurality from the plurality of actions.

In accordance with one preferred embodiment of the present invention, the searching means comprises genetic generation means for generating at least one of the new pluralities by applying a genetic operator on one of the plurality of proposed series.

In accordance with one preferred embodiment of the present invention, the selection means comprises saturation detection means for determining whether the storage means is saturated, identifies a least desirable proposed series of actions of the plurality according to the global desirability, and deletes the least desirable when the storage means is saturated.

In accordance with one preferred embodiment of the present invention, the computer program product further comprises input means for detecting an instruction, determining an evaluation parameter value according to the instruction, and setting the parameter value, wherein the evaluation means calculates the desirability value according to the parameter value.

In accordance with one preferred embodiment of the present invention, the input means comprises means for translating the instruction into the parameter value.

In accordance with one preferred embodiment of the present invention, the input means comprises means for determining the rate according to the instruction.

In accordance with one preferred embodiment of the present invention, the computer program product further comprises means for providing a series of previously selected actions and a series of previously detected state values, wherein the genetic generation means generates at least one of the new plurality by applying a genetic operation on a series of actions extracted from the series of previously selected actions.

In accordance with one preferred embodiment of the present invention, the computer program product further comprises means for providing a plurality of patterns, wherein the forecasting means forecasts the at least one state value that would be detected from the environment according to one of the plurality of patterns.

In accordance with one preferred embodiment of the present invention, the computer program product further comprises means for providing a plurality of patterns associated with a plurality of environments, wherein the input means determines the environment according to the instruction, the plurality of environments comprises the environment, and the forecasting means forecasts the at least one state value according to one of the plurality of patterns associated with the environment, whereby the forecasting means is capable of adjusting its functionality according to the environment.

In accordance with one preferred embodiment of the present invention, the forecasting means further comprises pattern-recognition means for identifying at least one pattern in the series of previously selected actions and the series of previously detected state values.

In accordance with one preferred embodiment of the present invention, the pattern-recognition means is a neural network comprising a plurality of input nodes for receiving at least one current state value and at least one action, and at least one output node for forecasting the at least one state value that would be detected from the environment.

In accordance with one preferred embodiment of the present invention, the computer program product further comprises means for providing a set of requirements to be satisfied by the new proposed series, wherein the searching means generates the new plurality according to the requirements, whereby the new plurality is more likely to have a higher desirability.

In accordance with one preferred embodiment of the present invention, the evaluation means comprises local calculation means for calculating local desirability values for actions comprised in the unvalued series of actions, and global calculation means for calculating a global desirability value from the local desirability values.

In accordance with one preferred embodiment of the present invention, the evaluation means comprises local calculation means for calculating local desirability values for actions comprised in the unvalued series of actions according to the at least one state value forecasted, and global calculation means for calculating a global desirability value from the local desirability values.

In accordance with one preferred embodiment of the present invention, the global calculation means attributes more weight to local desirability values for actions located at endings of series of actions, whereby the product is adapted to select actions to achieve a long-term goal.

### BRIEF DESCRIPTION OF THE DRAWINGS

FIG. 1 illustrates a prior art decision engine implemented using a Bayesian Network;

FIG. 2 illustrates a prior art decision engine implemented using a Genetic Algorithm;

FIG. 3 illustrates a prior art decision engine implemented as a Learning Agent;

FIG. 4 illustrates a general view of the engine of the present invention interacting with an environment;

FIG. 5 illustrates a detailed block diagram of the preferred embodiment of the engine of the present invention;

FIG. 6 illustrates a detailed block diagram of a preferred embodiment of a Seeker of the present invention;

FIG. 7 illustrates a detailed block diagram of a preferred embodiment of an Evaluator of the present invention;

FIG. 8 illustrates an example of an evaluation function when the present invention is applied to a navigation system for on-street vehicles;

FIG. 9 illustrates an environment associated with a particular application of the present invention for the purposes of providing an example;

FIG. 10 illustrates a detailed block diagram of the preferred embodiment of a Pattern-Recognizer of the present invention in the context of the particular application;

FIGS. 11 and 12 illustrate the path followed by sequences of actions in the context of the particular application of an embodiment of the present invention for the purposes of providing an example;

FIG. 13 illustrates the environment after an execution of a selected action, in the context of the particular application;

FIG. 14 provides examples of scenarios generated using genetic operators in the context of the particular application; and

FIG. 15 illustrates a detailed flow chart diagram of the decision-making process of one embodiment of the engine of the present invention.

FIG. 16 illustrates a detailed block diagram of a preferred embodiment of the engine of the present invention in the context of a second particular application for the purposes of providing a second example;

FIG. 17 illustrates a detailed block diagram of a preferred embodiment of a Seeker of the engine of the present invention in the context of the second particular application;

FIG. 18 illustrates a detailed block diagram of the preferred embodiment of an Evaluator of the engine of the present invention in the context of the second particular application;

FIGS. 19A to 19E illustrate the evolution of the content of a Store of Series of Actions during a letter-selection process of one embodiment of the engine of the present invention in the context of the second particular application; and

FIG. 20 illustrates a detailed flow chart diagram of a letter-selection process of one embodiment of the engine of the present invention in the context of the second particular application.

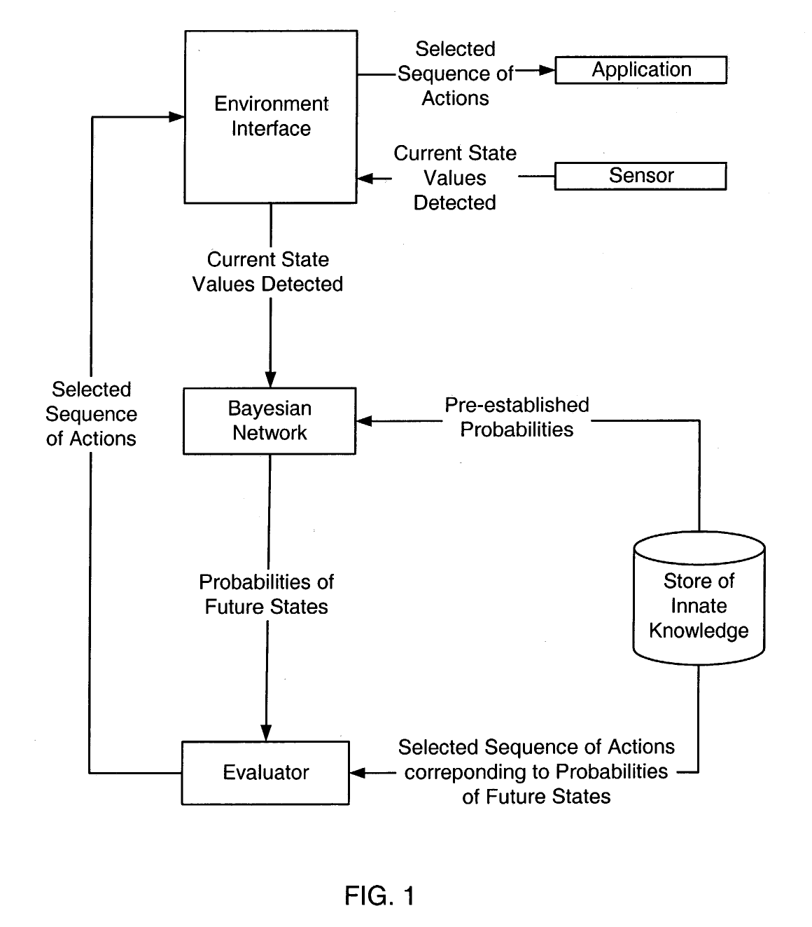

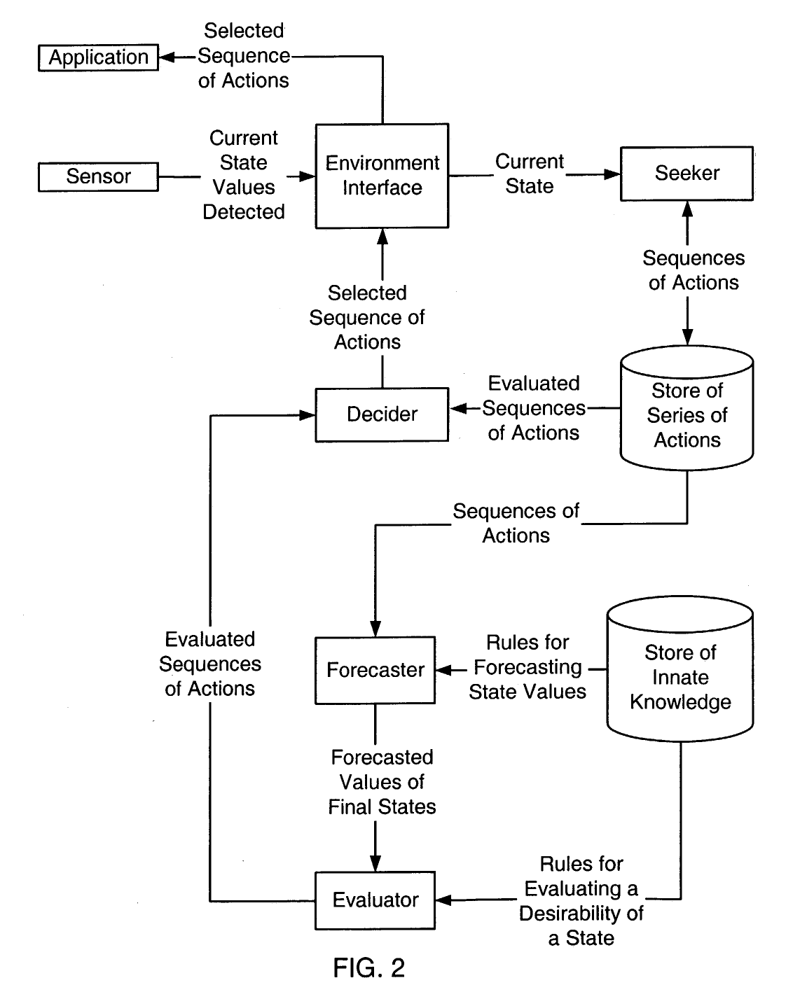

### DETAILED DESCRIPTION OF THE INVENTION

In accordance with the present invention, there is provided a decision engine combining the advantages of a search algorithm with the forecasting potential of pattern-recognition algorithms for a wide range of applications.

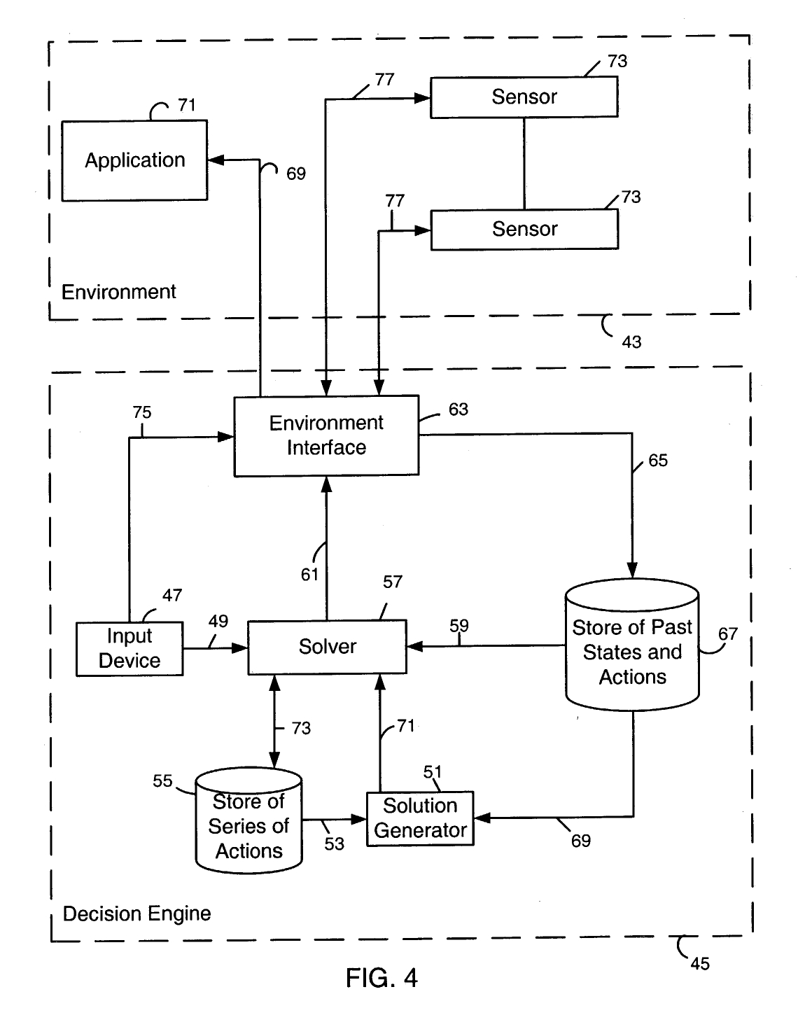

As illustrated in FIG. 4, a Decision Engine 45 of the preferred embodiment is completely separate from an Application 79 it controls, and an Environment 43 in which the Application 79 operates; however, it needs to be continuously updated with state information in order to keep track of the progress made towards reaching its goal. During the decision-making process, each state achieved and each action performed is stored in a Store of Past States and Actions 67. Such a setting is often encountered in computer games, a prominent theme in the field of decision theory. Pacman, among others, is well known in the art due to the complexity of its environment; it consists in leading a Pacman character through a maze with the purpose of eating as many dots as possible while avoiding roaming intelligent ghosts. In this particular context, an environment consists in a maze built with motion-blocking walls, wherein passageways are punctuated by regular dots, power dots, and bonus fruits. An application consists in a ghost capable of motion within the passageways of the maze. A decision engine is assigned to lead the ghosts through the maze, chasing a player-controlled Pacman, in an attempt to prevent the latter from eating all the dots, taking into consideration that the consumption of a power dot reverses the predator-prey relationship for a short lapse of time. In order to make appropriate decisions, the engine is regularly provided with the coordinates of the characters as well as those of the remaining edibles.

The Application 79 might be restricted to a single purpose, in which case the Engine 45 can be pre-configured to always aim for the same goal. However, in a preferred embodiment, the Engine 45 is used to control multi-purpose applications and users need to define its goal. For instance, in the example described above where the present invention is applied to Pacman, a user can instruct the Engine 45 to either lead the ghost as close as possible to the Pacman character, or protect remaining dots, power dots, or bonus fruits. User-defined goals are not permanent, and can be modified at any time through a user-friendly Input Device 47, such as a voice recognition system, which parses instructions, sends the corresponding evaluation functions 49 to the Solver 57, and sends the Interface 63 an instruction to send activation signals through a communication media 77 to the appropriate Sensors 73. This feature is very practical since users are not required to master any programming language, nor do they need to write any lines of code. For instance, in the case where the Engine 45 is applied to a navigation system for on-street vehicles, a driver would only need to orally convey the coordinates of his destination to establish a goal.

Initially, a user sets the Application 79 in its Environment 43, activates the Engine 45, and defines its goal, thereby triggering a creation of a wealth of random solutions by a Solution Generator 51, wherein each solution represents a random series of actions, or scenario. In the preferred embodiment, the Generator 51 is capable of yielding series of actions either randomly, or through the application of genetic operators on ones that were previously generated, or performed. These scenarios are thereafter sent through a communication medium 71 to a problem-solving component, or Solver 57, in order to have them evaluated. For each scenario received, the latter forecasts at least one of a plurality of intermediate states leading to a final state that would be achieved as a result of having the Application 79 perform corresponding sequences of actions, and attributes a desirability value based on the at least one forecasted state. The Solver 57 evaluates as many scenarios as possible within a time frame, at the end of which, it sends at least a first action of a scenario that received the best evaluation to the Interface 63 through a communication medium 61. The Interface 63 will in turn instruct the Application 79 to execute the action. The Solver 57 also sends the action is also sent to the Generator 51, in order for the latter to proceed with filtering solutions 53 stored in the Store 55. All scenarios that start with an action different from the one received, as well as those having a fitness level lower than a filter threshold are deleted, and the first action of the remaining scenarios is removed. The process is repeated until the Engine 45 reaches its goal.

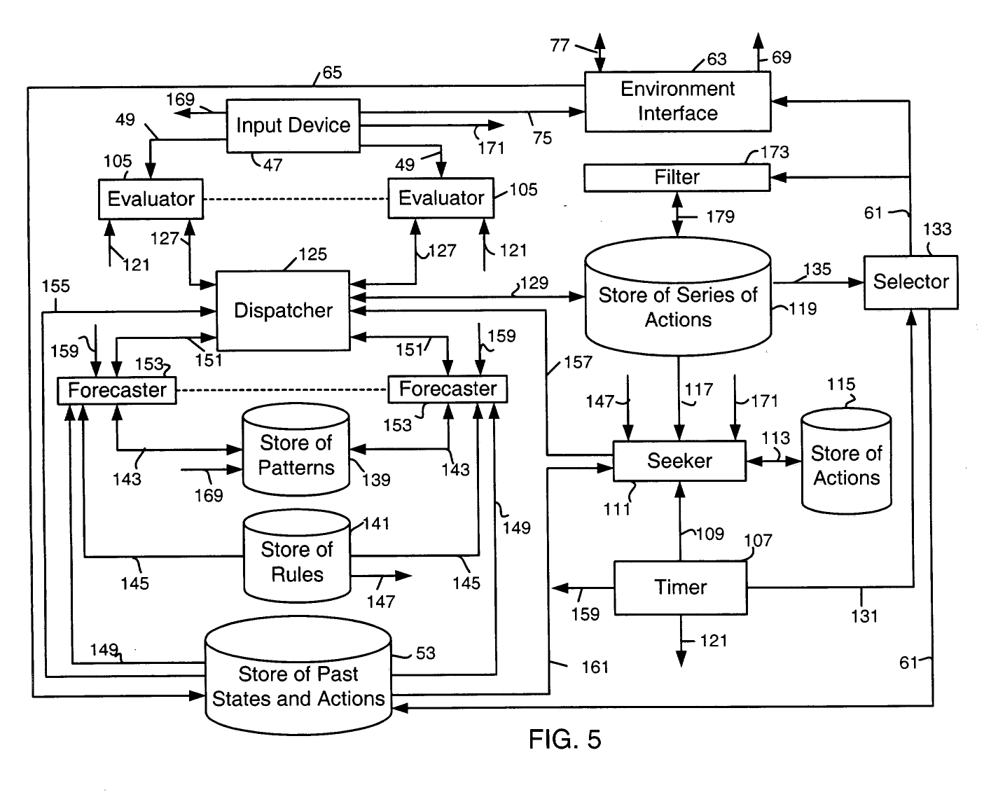

FIG. 5 provides a more detailed view of the preferred embodiment of the invention decorticating the generic components described herein above. The Solution Generator 51 comprises a Seeker 111, and a Filter 139, and the Solver 57, a Forecaster 153, a Selector 133, and an Evaluator 105. The Engine 45 also comprises three additional stores: a Store of Actions 115, a Store of Rules 141, and a Store of Patterns 139. The roles played by each component are explained herein below.

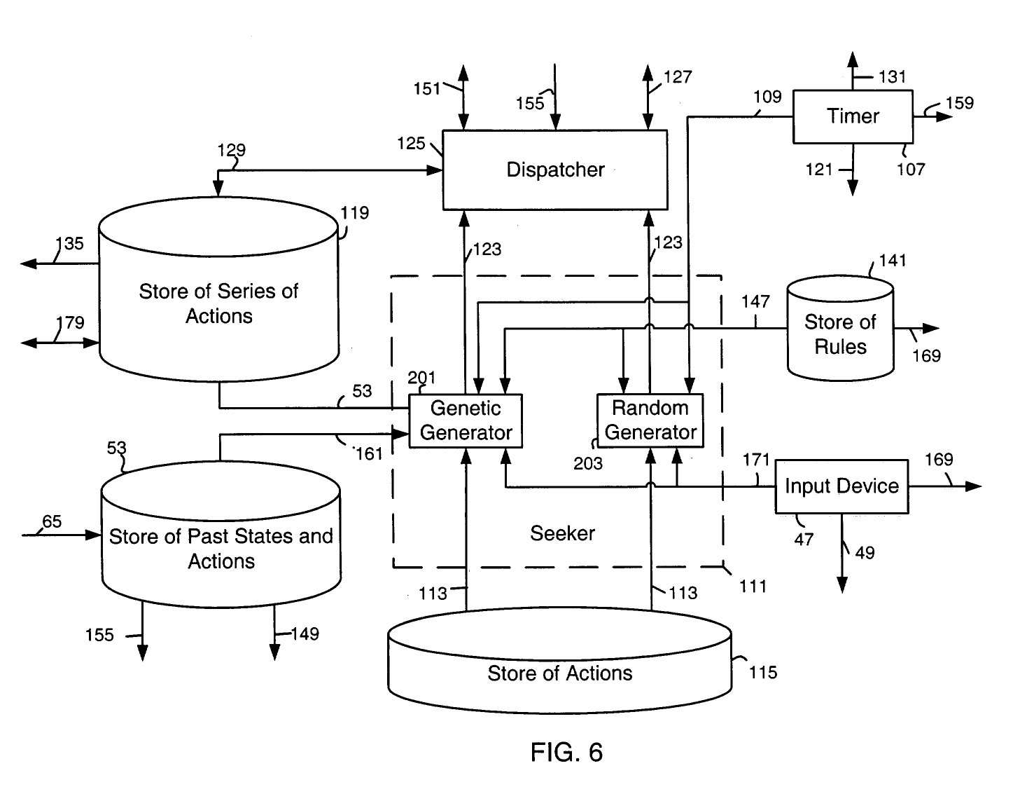

FIG. 6 illustrates a detailed block diagram of a Seeker 111 of the preferred embodiment. It comprises a Random Generator 201 and a Genetic Generator 203. Once the goal of the Engine 45 is defined through the Device 47, the Random Generator 137 selects actions 113 from the Store 115, orders them into sequences 123, and sends them to the Dispatcher 125. Each sequence can be viewed as a scenario that might lead the Application 79 towards achieving the defined goal. In the preferred embodiment, the Seeker 111 is capable of adjusting its functionality according to a variety of user-defined goals and environments by accessing goal-specific and environment-specific rules stored in the Store 141.

Effectively, once a goal and an environment are defined, the Device 47 instructs the Seeker 111, through signal 171, to retrieve the corresponding rules 147 from the Store 141. If no rules are defined in the Store of Rules 141, scenarios are generated completely randomly in terms of their length and content. However, if rules are implied by the defined goal and Environment 43, the Seeker 111 is programmed to generate scenarios accordingly.

In the case where the Engine 45 is applied to a navigation system for on-street vehicles, each action in a scenario could represent either a proposed direction for a segment slightly shorter than a minimal street width from Right Turn, Left Turn and Straight, or a Sleep Period. Each scenario would then be comprised of a random number of actions greater than a minimal number required to establish a substantial path.

In another case where the Engine 45 is applied to a variant of the Traveling Salesman Problem (TSP) described in “On the Hamiltonian Game (A Traveling Salesman Problem)” by Julia Robinson (1949) where it is required to find a least time-consuming round-trip in a dynamic environment, each action in a scenario could represent a trip from a city reached as a result of all previous actions in the scenario, to another. All sequences would then have as many actions as there are cities left to visit, and end with a trip from a last city reached to a starting point.

In yet another case where the present invention is applied to Pacman, the Store 115 comprises five actions through which the ghost can be instructed to move right, left, up, down, or maintain its current position. In order to increase the efficiency with which the Engine 45 converges in the solution space, the Store 141 comprises a rule preventing the Seeker 111 from generating scenarios that start with an action that cannot be performed in a current state of the Environment 43. On the other hand, the length of generated scenarios is random as the Engine 45 is never aware of the number of steps required to achieve its goal.

While an initial capital of scenarios is being generated, the Dispatcher 125 sends a subset of scenarios to each Forecaster 153. Each Forecaster 153 is therefore responsible for a sub-population of scenarios. This embodiment is particularly efficient for real-time applications, since parallel processing allows for a greater number of scenarios to be analyzed within a time frame. For each scenario received, a Forecaster 153 forecasts at least one intermediate state that would be achieved as a result of having the Application 79 perform a corresponding sequence of actions. In one embodiment, the Forecaster 153 forecasts all intermediate and final states for each scenario received.

In the case where the Engine 45 is applied to the variant of the TSP described herein above, the Forecaster 153 would forecast the time taken to travel between two corresponding cities. In one embodiment of the invention, the forecasting could be performed according to U.S. Pat. No. 6,317,686 titled “A METHOD OF PROVIDING TRAVEL TIME” by Ran, wherein a time taken to travel from one city to another, as part of a scenario comprising a sequence of cities to be visited, is determined according to a city of departure, a city of destination, a time of departure at which the city of departure is expected to be reached as a result of previous trips scheduled in the scenario, and a provided weather forecast corresponding to a period of time during which the traveling is expected to take place

As for the case where the Engine 45 is applied to a navigation system for on-street vehicles, the Forecaster 153 would forecast an average speed of a vehicle along a street segment according to a period of time during which the vehicle is expected to follow the segment, as well as provided weather and traffic forecasts.

In the preferred embodiment, during the first iterations of the decision making process, the Forecaster 153 will mainly rely on an innate knowledge of the Environment 43, stored in the Store 141. For every action in a sequence, and a state in which the action would be performed, the Forecaster 153 searches for an applicable rule 145 stored in the Store 141 that indicates a resulting state. For instance, in one embodiment of the present invention as applied to Pacman, one of the rules specifies that if the ghost is found in a state where move X is allowed, an action indicating move X results in a unitary shift of the coordinates of the ghost in a corresponding direction. Such rules are clearly not sufficient for forecasting states in all their complexity, and only provide support during the initial steps. Once the Engine 45 has accumulated a sufficient amount of experience, the Forecaster 153 will rely on its Pattern-Recognizer instead of the Store 141.

The Recognizer analyses past states and actions retrieved by the Forecaster 153 from the Store 53 through communication media 149 to identify patterns and establish causal links. In the preferred embodiment, the Recognizer is implemented as a neural network that receives a sequence of states and actions through its input nodes, and provides a corresponding forecasted state through its output nodes. If the Recognizer is configured to detect causal relationships over s steps, a state is characterized by m features, and an action, by n, then the corresponding neural network would have s*(m+n)+n input, and m output nodes. The additional n nodes are for receiving the proposed action for a current frame. When analyzing a sequence of actions of length 1, for each k^{th} action of the sequence, where k ranges from 1 to l, the first (s−k+1)*(m) would receive the (s−k+1) most recently achieved states and actions, the following (k−1)*m nodes, the (k−1) first forecasted states of the sequence of actions, the following (s*n), the s actions corresponding to the states entered in the previous nodes. The final n nodes are for receiving a last action, which resulting state is to be forecasted and provided through the output nodes. It will be obvious to one of ordinary skill in the art that the order of the nodes is not restricted to the one described herein above.

In order for the Recognizer of the preferred embodiment to be functional, it must first have its neural weights adjusted through training. The Recognizer is trained at the beginning of each frame, from the moment a decision is taken until the activation of the forecasting process. The training set corresponds to a subset of the data comprised in the Store 53; it could either be selected randomly, or correspond to the last frames. Its size is only limited by the time available for the training process, the speed with which training is performed, and the amount of data available in the Store 53. The training proceeds by providing the network with a sequence of past actions and resulting states through its input nodes, feed-forwarding the output, and back-propagating the mean square error between the achieved state and the forecasted one provided at the output of the network.

In one embodiment, patterns are stored as weights calculated during the training process, and the Store 139 represents the storage space dedicated to those weights and provided by neurons of the network. However, in the preferred embodiment, the Store 139 is separate from the network, and every time the Engine 45 is assigned to a previously encountered environment having features that distinguish it from others, the Device 47 instructs the Recognizer through signal 169 to store its weights in the Store 139, label them as being associated with a last environment, and retrieve from the Store 139 weights corresponding to the designated environment.

In order to determine whether a Recognizer of the preferred embodiment is sufficiently trained, another subset of the data comprised in the Store 53 is used to calculate its success rate. In one embodiment, if the testing set comprises c cases, the success rate is obtained by dividing the number of state information correctly forecasted during the testing process by (c*m), and multiplying the result by 100. If a calculated success rate is greater than a user-defined threshold, the Recognizer is deemed sufficiently trained to significantly contribute to the forecasting process.

In an embodiment specific to the case where the present invention is applied to Pacman, the Recognizer is required to detect causal relationships over ten steps, and has therefore ten groups of input nodes, each of which is dedicated to a state and comprises nodes for receiving coordinates of all characters and remaining edibles, as well as a current status of the Pacman character. The Recognizer further comprises ten additional groups of nodes, each of which is dedicated to an action. Since five types of actions are available to the Engine 45, each group dedicated to an action comprises five nodes. The input also comprises an eleventh group of node, for receiving a last action, which resulting state is to be forecasted by the Recognizer and provided through output nodes. The output is comprised of the same type of nodes as the first ten groups found at the input since it also defines a state, namely the one forecasted to result from the sequence of states and actions received through the input nodes.

In another, simpler embodiment, the Recognizer identifies exact patterns according to their frequency in the Store 53 and stores them through a communication medium 143 in the Store 139.

Prior art decision engines are known to train, test, and use neural networks, wherein input nodes receive state information, and output nodes provide responsive actions or forecasted states. However, they are not known to forecast a sequence of intermediary and final states that would be achieved as a result of having a slave application perform a sequence of actions in a current state, and evaluate a fitness of the sequence according to the forecasted states. This feature allows the Engine 45 to effortlessly adapt itself to new goals and functions by associating scenarios with intermediary and final states rather than desirability values.

Once all intermediary and final states are forecasted, they are sent, along with their corresponding scenario to a Dispatcher 125 through a communication medium 151.

The Dispatcher 125 sends a subset of scenarios through communication media 127 to each Evaluator 105 according to its capacity. Each Evaluator 105 is therefore responsible for analyzing a subpopulation of scenarios. This embodiment is also particularly efficient for real-time applications, since parallel processing allows for a greater number of scenarios to be analyzed within a time frame. The Evaluators 105 send evaluated scenarios and their fitness level back to the Dispatcher 125, through the media 127, in order to have them stored in the Store 119. The latter has a limited, implementation-dependent, amount of space. In the preferred embodiment, the Store 119 comprises a Saturation Detector, or Comparator, which is capable of detecting whether the Store 119 is saturated. In the case where the Store 119 is saturated, the Selector 133 searches for and deletes a scenario having a lowest desirability value.

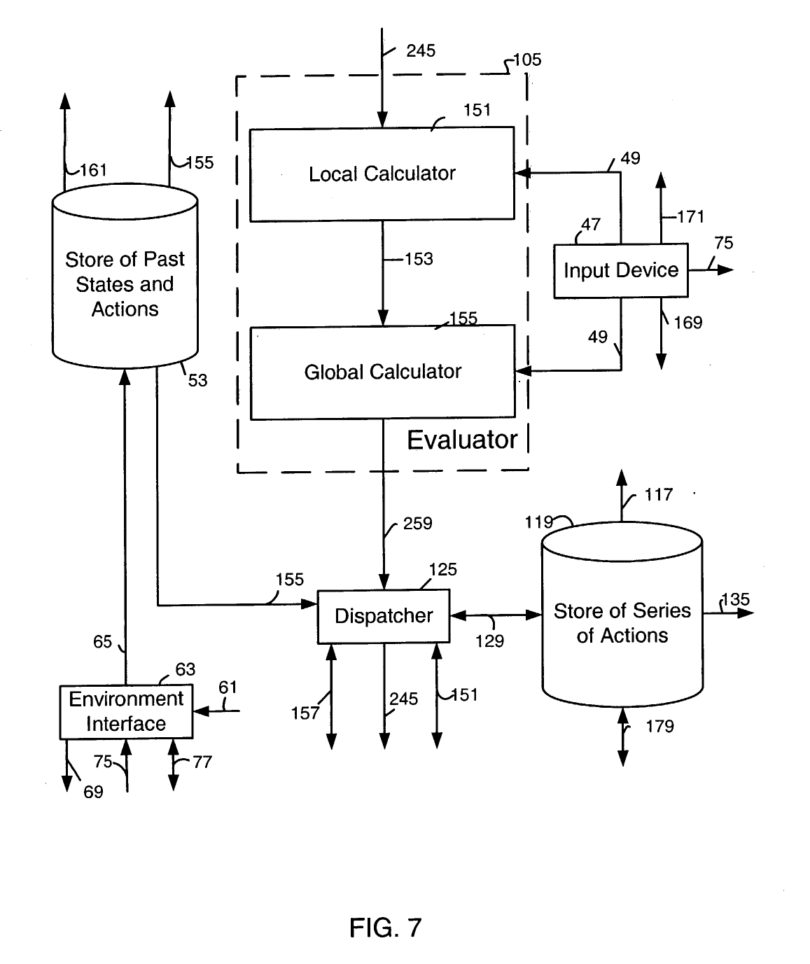

A detailed block diagram of an Evaluator 105 of the preferred embodiment is presented in FIG. 7. It comprises a Local Calculator 151, or calculator of desirability value of actions, and a Global Calculator 155, or calculator of desirability value of series of actions. A first step of an analysis of a scenario 145 is performed by the Calculator 151, and consists in assigning a local desirability value (LDV), or desirability value of actions, to each action encountered in the scenario 145, which represents a level of satisfaction that the Application 79 would achieve after performing the corresponding action according to forecasted state parameter values.

In the context of the Pacman game described herein above, the calculation of LDVs depends on the user-defined goals. If the user assigns the Engine 45 to chase the Pacman character, the LDV is the distance between them, and the higher an LDV, the lower the desirability of a corresponding action. If, on the other hand, the Engine 45 is assigned to protect the remaining power dots, regular dots, or bonus fruits, the LDV represents a number of remaining edibles of the selected type. In this case, the higher an LDV, the higher the desirability value of a corresponding action. The Engine 45 can also be simultaneously assigned to multiple goals. For instance, the user might want to have the ghost chasing Pacman while steering him away from a closest regular dot. In this case, LDVs are calculated by subtracting a weighted distance between the Pacman character and the ghost from a weighted distance between the Pacman character and a closest regular dot, wherein weight values depend on which goal is identified as having priority over the other.

In the case where the Engine 45 is applied to the variant of the TSP described herein above, the LDV of an action would generally correspond to the forecasted time taken to travel between two corresponding cities. However, recurring actions in a scenario as well as those that had been previously performed would be attributed a discriminating value such that they would not be selected since the problem clearly states that each city can only be visited once. The Calculator 151 would identify a previously performed action by maintaining a list of visited cities according to geographical data provided by Sensors 77 through the Interface 63. It is important to note that in this particular case, the greater the LDV of an action, the less desirable it is.

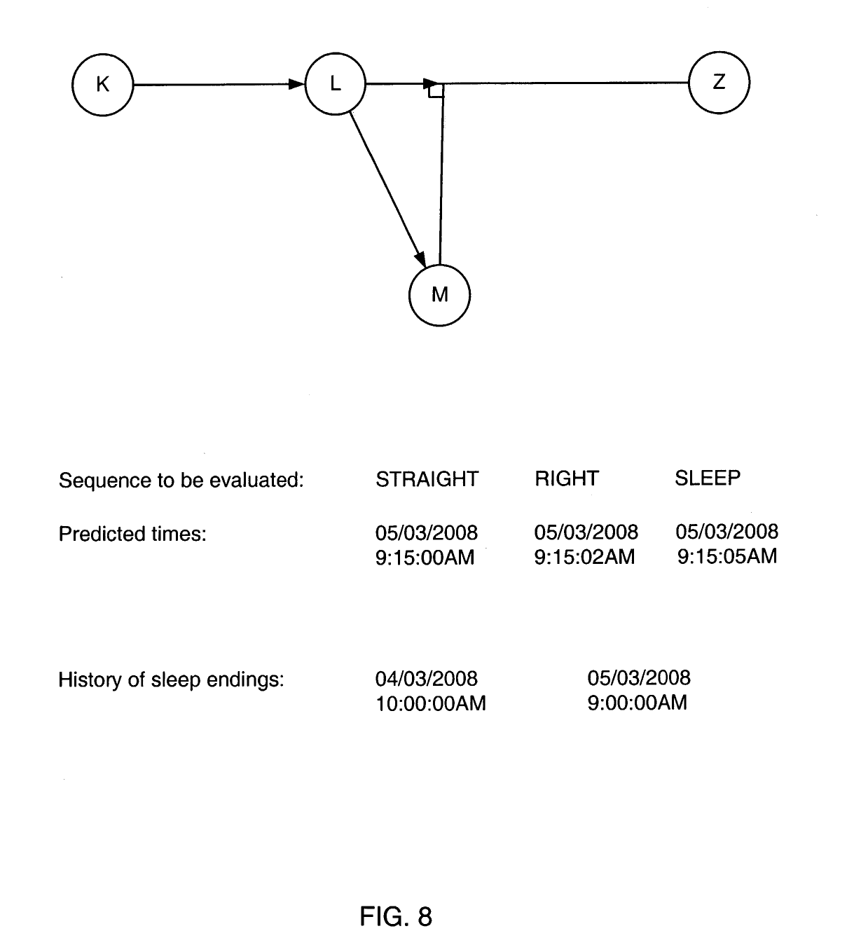

As for the case where the Engine 45 is applied to a navigation system for on-street vehicles, the LDV of an action representing a direction would correspond to the forecasted average speed of a vehicle towards a final destination from a forecasted position reached, and resulting from following the proposed direction for a segment slightly shorter than a minimal street width. The Engine 45 would be connected to a global positioning system through the Interface 63, and the Calculator 151 would comprise a database of maps corresponding to cities where the navigation system might be used in order to locate a current position of the vehicle on a map, given global coordinates, and predict positions it would have as a result of following actions in a scenario. The Calculator 151 would also comprise a list of minimal street widths corresponding to every city where the navigation system might be used. In the example shown in FIG. 8, for an action in a scenario suggesting a right turn towards position M at the time when position L is expected to be reached according to previous actions in the scenario, if according to weather and traffic forecasts corresponding to a period of time during which the vehicle is expected to follow segment [LM], an average traveling speed x along segment [LM] is expected to be 50 km/h, and if segment [LZ] is at an angle α of 60 degrees from segment [LM], where Z would represent a final destination, the LDV would be x*cos(α)=25. As for actions representing sleep periods, their LDV would rely on an amount of sleep selected, or scheduled in a scenario in which they are comprised, 24 hours prior to a time at which they are expected to start. In one embodiment, the Calculator 151 would maintain a history of sleep endings covering the last 24 hours, as well as a list of speed limits corresponding to cities where the navigation system is expected to be used in order to minimize the occurrence of 24-hour periods of travel without sleep. For instance, if the navigation system is used in a city that has a maximum speed limit of 100 km/h, and sleep periods last 8 hours, the Calculator 155 could attribute LDVs according to function LDV(t1, t2)=5+(t2−t1)*6, where t2 represents a time at which a sleep period is expected to start, and t1, the time at which a last selected or scheduled sleep period has ended or is expected to end during the 24 hours that precede t1, such that when a driver has not slept for 16 hours, the LDV of an 8-hour sleep period is equivalent to that of an action allowing a progress towards the final destination at an average speed of 101 km/h, which is higher than that of any other action since the maximum speed limit is 100 km/h. In the particular case shown in FIG. 7, and according to the LDV function described herein above, the 8-hour sleep period found in the third position of the sequence to be evaluated would be attributed a LDV of 4415. It is important to note that in this particular case, the greater the LDV of an action, the more desirable it is.

Once assigned, all LDVs 153 of a scenario are sent to the Calculator 155, which, in turn, calculates a weighted sum that represents its level of fitness, referred to as a Global Desirability Value (GDV), or desirability value of series of actions. The latter provides for a refined way of comparing scenarios, as Evaluators 155 take into account additional fitness factors by adjusting weights of the LDVs. For instance, in the case of the Pacman game, if the Recognizer has a success rate deemed low, but sufficient to provide more accurate forecasting support than the Store 141, the Calculator 155 attributes more weight to LDVs associated with actions located at a beginning of a sequence. As the Recognizer undergoes further training sessions and improves its success rate, the weight attributed by the Calculator 155 shifts towards LDVs associated with actions located at an end of a sequence.

Scenarios and their GDVs 259 are sent to the Dispatcher 125 in order for them to be stored in the Store 119 in a way such that scenarios are always ordered according to their GDV, and can be easily traced back therefrom.

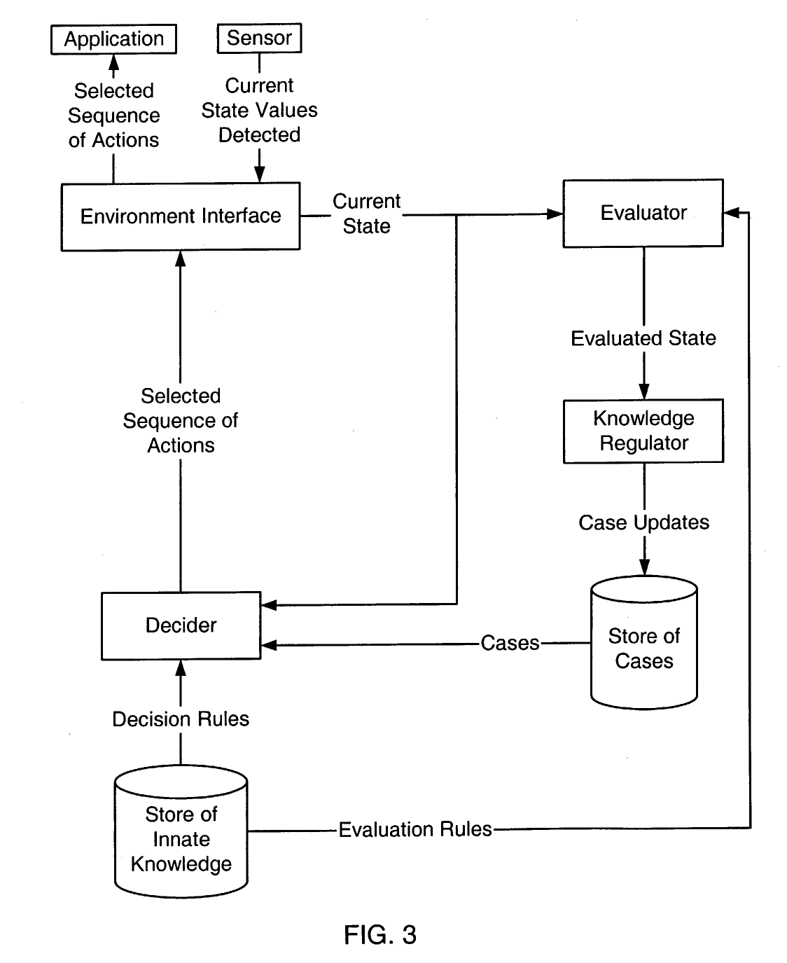

Since the Engine 45 is designed to guide the Application 79 in a progressive manner, decisions are expected at a regular interval, and the evaluation process described herein above is constrained to a time frame at the end of which, a decision must be taken. In the preferred embodiment, referring back to FIG. 3, a Timer 107 sends at the end of each frame inactivation signals 109, 159, and 121 to the Seeker 111, the Forecasters 153, and the Evaluators 105 respectively, thereby halting the generation of scenarios, the forecasting and the evaluation processes, and initiating a training session for the Recognizers 163. In the mean time, an activation signal 131 is sent to the Selector 133. Once activated, the latter retrieves a fittest scenario 135 available in the Store 119, and sends at least its first action 61 to the Interface 63, which, in turn, sends an instruction 69 to the Application 79 for the execution of the action 61. The latter is also stored in the Store 53. Once the action 61 is achieved, the Sensors 73 detect and send resulting state parameter values through the media 77 to the Interface 63 in order for them to be stored in the Store 53 through data signal 65.

Although the signal 109 is described as an inactivation signal, it would serve an additional purpose in the case where the Engine 45 is applied to the variant of the TSP described herein above. In order for the Seeker 111 to generate scenarios comprised of as many actions as there are cities left to visit, it would keep count of a number of cities to be visited by counting a number of cities initially available in the Store 119, and decrementing the number by one every time it receives the signal 109, since the latter indicates that a city will be shortly selected.

When the Engine 45 is handling an intricate assignment, the fittest scenario can very often be distant from an optimal solution for a number of reasons.

This weakness partially stems from time constraints dictated by user-defined goals and environments; the Evaluators 105 do not have enough time to analyze all possible solutions. In addition, abilities of the Evaluators 105 are hampered by sensors' inaccuracies as well as the occurrence of random events, which can severely depreciate the GDV of a scenario shortly after it has been selected.

Therefore, by instructing the Application 79 to perform a limited number of actions of a fittest scenario 135, the Selector 133 limits the detrimental effects of evolving environments, real-time constraints, and inaccurate sensing, and allows the Engine 45 to continuously readjust its plans. Although some prior art decision engines do provide such flexibility, they are less efficient in converging towards a goal than the present invention.

In the preferred embodiment, the number of actions sent to the Interface 63 depends on the goal of the Engine 45, a state of the Environment 43, the Environment 43 itself, and the actions of the selected sequence. For instance, in the case described herein above where the Engine 45 is applied to a navigational system for on-street vehicles, the Selector 133 would send a minimal number of actions to the Interface 63 in order to provide the driver with paths, rather than single actions. Paths could be provided on a map displayed on a screen linked to the Interface 63.

The action 61 is also sent to the Filter 139, which retrieves all evaluated scenarios through a communication medium 179, and deletes those that start with a different action, thereby freeing up memory space for a new generation. Those scenarios are deemed insignificant, even if they rank among the fittest in the Store 119, because a value of each action in a sequence depends on its predecessors. Of the remaining scenarios, those having a lower GDV than a pre-determined filtering threshold are removed from the Store 119, while the others are stripped from their common first action since it has already been sent to the Application 71. The resulting beheaded scenarios are evaluated and stored back in the Store 119 to play a role of progenitors for a following generation. In the preferred embodiment, the filtering threshold is calculated by a Threshold Calculator comprised in the Filter 139 as an average GDV of all possible scenarios starting with the selected action 61. It allows the engine to filter out scenarios that are likely to be less suitable progenitors than randomly generated ones, thereby accelerating its convergence towards the goal. Although some prior art decision engines might be more efficient in some particular situations, they fail to provide the flexibility and fault-tolerance required to be as consistently efficient as the engine of the present invention when operating in a dynamic environment.

Once the action is performed, and the resulting state is detected, the Store 119 is repopulated by the Seeker 111. Referring to FIG. 6, the Generator 137 generates scenarios 117 randomly to explore new possibilities by selecting a random number of random actions and ordering them into sequences. The Seeker 111 also comprises a Genetic Generator 143, which applies genetic operators on series of actions 117 extracted from the Store 115, and the Store 53, in order to generate scenarios 117. In one embodiment, a set of genetic operators available to the Generator 143 comprises:

a) A mutation, for which it selects one of existing scenarios, goes through the sequence of actions, replacing some by random ones according to user-defined probabilities.

b) A crossbreeding, for which it selects two of existing scenarios and randomly chooses either a first action of scenario 1 or a first action of scenario 2, as a first action of a new scenario, a second action of scenario 1 or a second action of scenario 2, as the second one, and so on until one of the scenarios is exhausted, in which case, the remaining actions of the other scenario are appended to the new scenario.

c) A reevaluation, for which it selects one of existing scenarios, and passes it on exactly as it is.

d) A prolongation, for which it selects one of existing scenarios, and a random length, x, by which to lengthen it. Subsequently, it selects x random actions and appends them at the end of the selected scenario.

In the preferred embodiment, genetic operators and the selection process of candidate scenarios for genetic operations are adjustable according to the goal of the Engine 45, the Application 79 as well as its environment. For instance, in situations where the scenario evaluation process is deemed accurate, it might be advantageous to have the Seeker 111 select candidate scenarios having a higher GDV with a higher probability than their peers. Another valuable adjustment would consist in attributing higher mutation rates to actions having a lower LDV in the case where the level of dependence of an action's LDV on its peers is low. All adjustments 147 related to the scenario generation process are stored in and retrieved from the Store 141.

While the breeding is performed, the Dispatcher 125 sends scenarios 127 to the Evaluators 105, which marks the start of a new iteration. The process is repeated until the Engine 45 reaches its goal, or is deactivated.

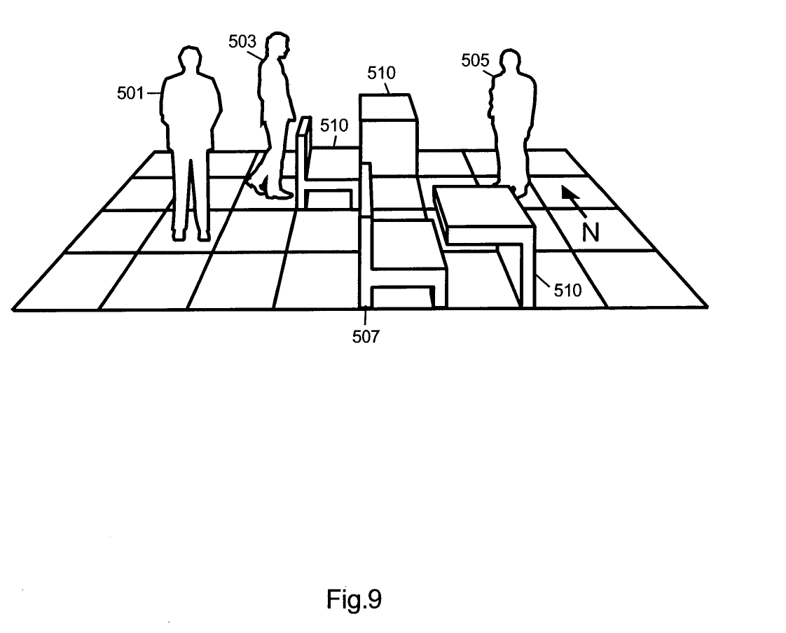

The following description refers to a specific application of the present invention in an environment illustrated in FIG. 9. The goal of the Engine 45 is to lead a Main Character 503 to position 507. Every time an action is selected, the Character 503 attempts to move one square in the corresponding direction. Furthermore, the Environment 43 comprises autonomous dynamic Characters 501 and 505 as well as static Objects 510; when the Character 503 hits one of them, it returns to its previous square. The Engine 45 is aware of the presence of the Objects 510, but has no information regarding their coordinates. As for the Characters 501 and 505, the Engine 45 is provided with their coordinates, but not their motion patterns.

Actions are implemented as objects that hold four binary values, A₁, A₂, A₃, and A₄, each of which is associated with a specific type of move. The Store 141 comprises a rule indicating that diagonal moves are prohibited due to the configuration of the labyrinth; therefore, only one of A₁, A₂, A₃, and A₄ can have a value of 1 in a single object. For the purposes of the example, A₁, A₂, A₃, and A₄ represent a move towards the west, east, north, and south respectively.

States of the Environment 43 are characterized by coordinates of the Characters 501, 503, and 505, as well as options of the Character 503 with respect to its next action. They are implemented as objects that hold ten values, each of which represents a specific type of information. For the purposes of the example, S₁ represents the longitudinal coordinates of the Character 503, S₂, the latitudinal ones, S₃ and S₄, the coordinates of the Character 501, S₅ and S₆, those of the Character 505, and S₇, S₈, S₉, and S₁₀ respectively indicate whether the Character 503 can move west, east, north, and south. S₁, S₃, and S₅, and S₂, S₄, and S₆ hold integer values ranging from 0 to the greatest longitudinal and latitudinal coordinates respectively, whereas S₇ to S₁₀ hold binary values.

Referring back to FIG. 5, in one embodiment of the present invention for this specific application, the Store 115 comprises five objects associated with the motional capabilities of the Character 503: object W holds sequence 1 0 0 0, and corresponds to a move towards the west, object E, sequence 0 1 0 0, and corresponds to a move towards the east, object N, sequence 0 0 1 0, and corresponds to move towards the north, object S, sequence 0 0 0 1, and corresponds to a move towards the south, and object Wait, sequence 0 0 0 0, and corresponds to a wait move where the Character 503 is prevented from actively modifying its coordinates. The Store 67 is implemented as two arrays, the first of which contains 5000 state objects, and the second, 5000 action objects. The Store 119 is also implemented as two arrays, the first of which holds 1000 action objects, and the second, 100 integers. It is capable of holding up to 100 sequences of actions, each sequence comprising 9 actions or less. The Seeker 111 is capable of generating 100 000 sequences per second, and the Forecasters 153 and Evaluators 105 are capable of handling 100 000 sequences per second.

Still referring to FIG. 5, each Evaluator 105 comprises the Calculators 151 and 155 described herein above. For this specific application, Calculators 151 attribute to each action a LDV that represents the number of squares separating the Character 503 from its final destination. Therefore, a value of 0 indicates that the destination is reached, whereas a value of 3 indicates that the Character 503 stands three squares away. Once all LDVs of a sequence have been attributed, they are sent to the Calculator 155, which calculates their weighted average, or GDV, wherein a position j of an action in a sequence is associated with a weight W(j)=10−j. In this particular case, the higher the GDV, the lower the fitness level of the corresponding scenario.

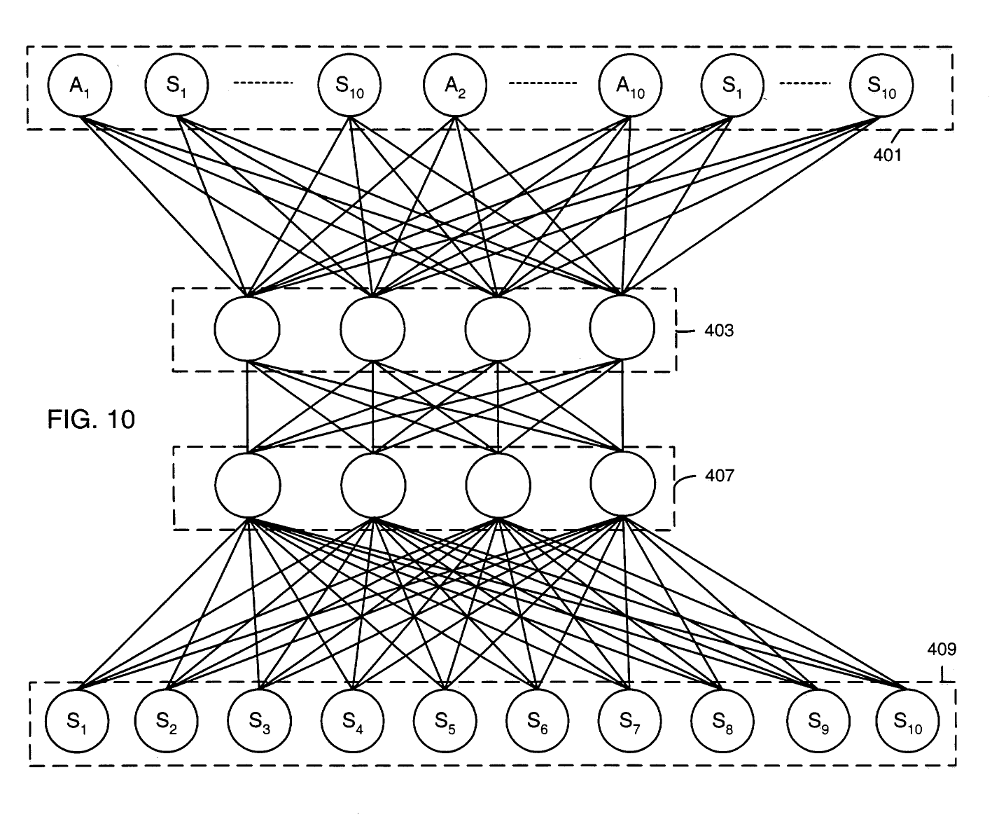

FIG. 10 provides a detailed diagram of an embodiment of the Recognizer for this specific application. A feed-forward, back-propagating neural network with two hidden layers 403 and 407 of four nodes each is deemed appropriate for handling the level of complexity implied by the defined goal and Environment 43.

The Recognizer is configured to detect causal relationships over 10 steps and, as a result, the corresponding network requires 10*(10+4)+4=144 input nodes 401, and 10 output nodes 409.

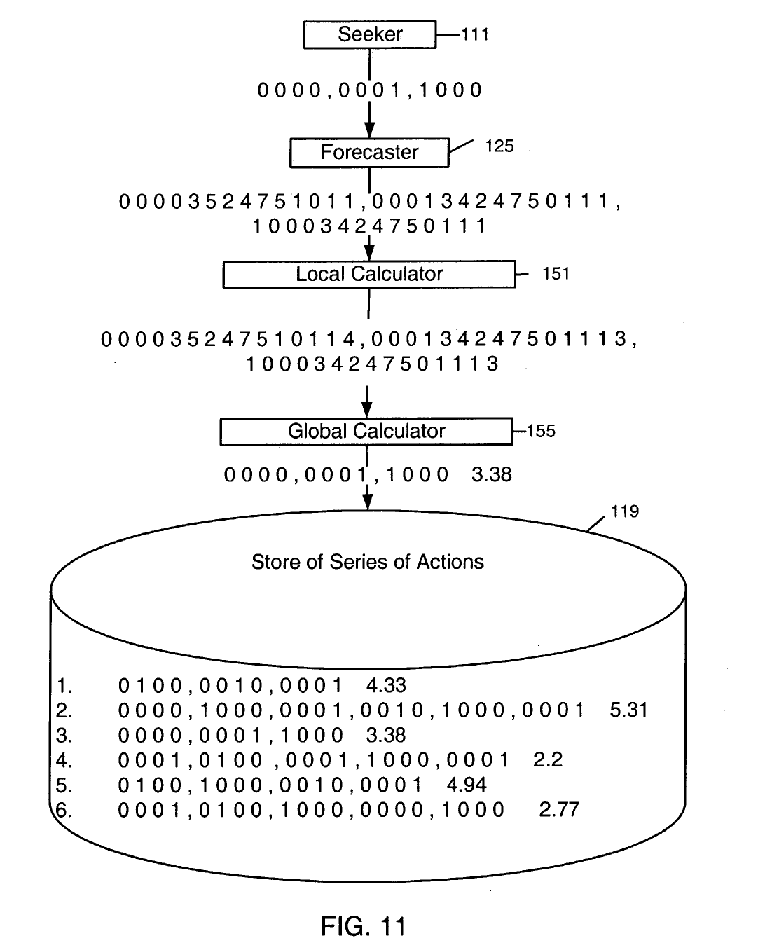

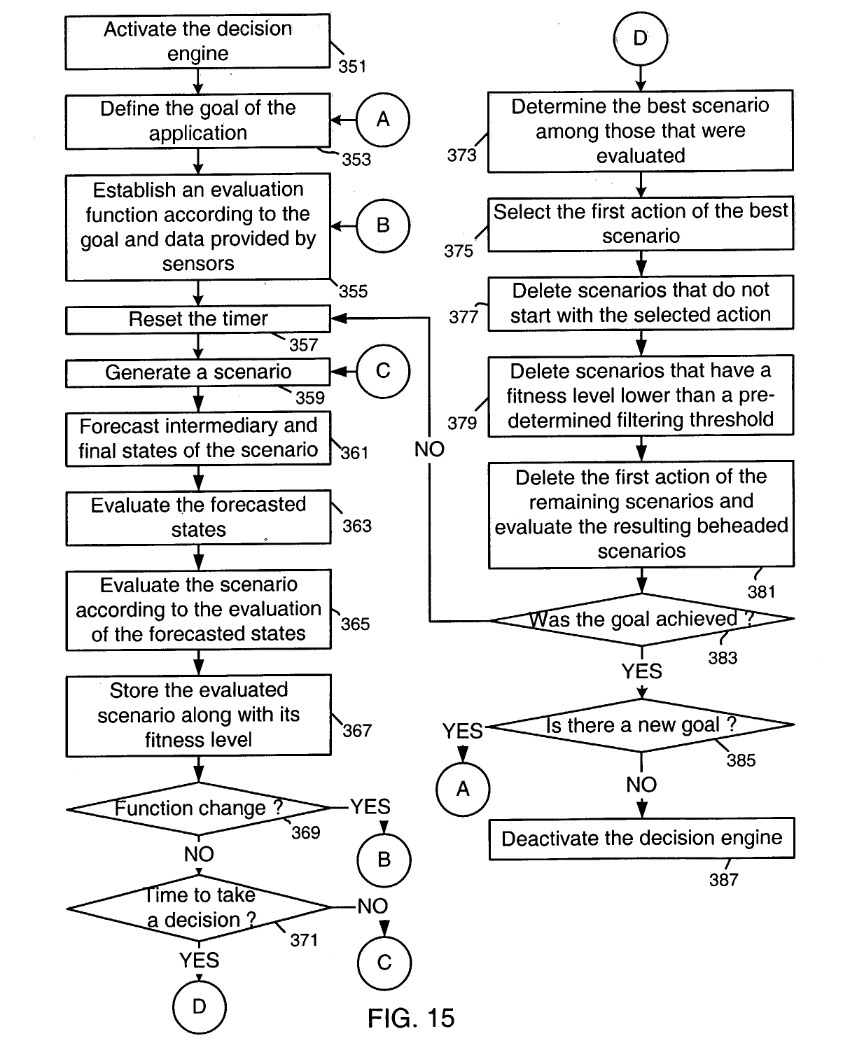

Referring to FIGS. 11, 12, and 15, there are shown diagrams illustrating the evolution of a scenario during the decision-making process, and a flow chart describing the process itself. The latter can be broken into two sub-processes, the first of which, serves the purpose of initializing the Engine 43. Referring to FIG. 15, the user activates the Engine 43 251, and defines its goal 253: leading the Character 503 to the position 507, of coordinates (6, 3). The last step of the initialization sub-process consists in having the Engine 43 retrieve an active evaluation function 255 corresponding to the given goal, and a state of the Environment 43 provided through the Sensors 73. A state of the Environment 43 comprises the coordinates of the Characters 501, 503, and 505, which, according to FIG. 9, correspond to (3, 5), (2, 4), and (7, 5) respectively, as well as an indication as to which action is allowed to be chosen for the following frame. Still according to FIG. 9, all actions are allowed except for 0 1 0 0, which corresponds to a move towards the East.

The second sub-process is iterative, and executed until the destination defined by the user has been reached. Its first step consists in generating a random scenario 257. In the case illustrated in FIG. 10, sequence 0 0 0 0 0 0 1 0 1 0 0 0 is generated, which encodes an instruction to maintain a current position in a first frame, move down in the second, and left in the third. The scenario is completely random at this point as the Store 119 is empty. However, once the Store 119 is sufficiently filled, the Engine 43 alternates between random and genetic generation processes in order to converge towards local optima in the corresponding solution space.

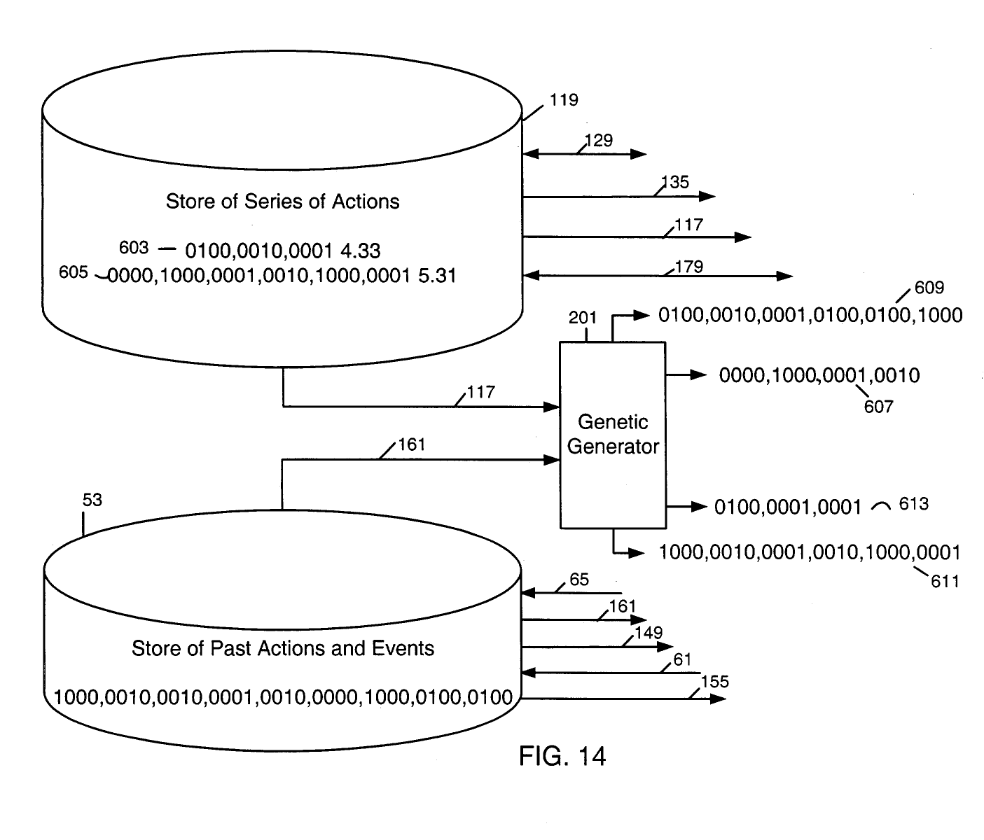

FIG. 14 illustrates how genetic operators can be applied in generating scenarios from previously generated ones. A scenario 607 results from a deletion, or more specifically, the removal of the last two actions of a scenario 605. A scenario 609, on the other hand, results from a prolongation, or more specifically, the concatenation of actions 0 1 0 0 0 1 0 0 1 0 0 0 to a scenario 603. Another scenario, 611, results from a mutation, or more specifically, the replacement of its second action 0 0 1 0 by 0 0 0 1. Finally, a scenario 613 results from the crossover of a scenario 601 and the scenario 605.

Once a scenario is generated, its intermediary and final states are forecasted 361, wherein each state is expressed as a sequence of ten parameters, S₁ to S₁₀.

During initial frames, the Forecaster 153 relies on an innate knowledge of the Environment 43, stored in the Store 141, to forecast state parameter values. For this particular Environment 43, the Store 141 indicates that the selection of an action results in a move of the Character 503 in the corresponding direction except for cases where a destination square is occupied by one of the dynamic Characters 501 and 505. As for forecasted positions of the latter, they are established by assuming that they will maintain their course of action. In the case illustrated in FIG. 11, sequence 0 0 0 0 0 0 1 0 1 0 0 0 is sent to the Forecaster 153, which, in turn, outputs sequence 0 0 0 0 3 5 2 4 7 5 1 0 1 1 0 0 0 1 3 4 2 4 7 5 0 1 1 1 0 0 0 3 4 2 4 7 5 0 1 1 1, a combination of actions and forecasted resulting states. According to the sequence, after performing action 0 0 0 0, the Character 503 will maintain its current position, (3, 5). As for the Characters 501 and 505, they will also maintain their position, (2, 4) and (7, 5), since they did not move between the penultimate, and ultimate frame. Since action 0 0 0 0 does not imply a change in the coordinates of the Character 503, and the Characters 501 and 505 are not expected to be positioned in the squares adjacent to that of the Character 503, the latter is allowed to move left, right, up, or down, and therefore, each of S₇, S₈, S₉, and S₁₀, is attributed a value of 1.

During later frames, the Forecaster 153 relies on the Recognizer to calculate state parameter values. In the case illustrated in FIG. 11, if the Recognizer is deemed sufficiently trained, the Forecaster 153 ignores the content of the Store 141, and retrieves the last ten actions and states achieved from the Store 53. Subsequently, the Recognizer reads the retrieved states and actions along with action 0 0 0 0 through its input nodes in order to output ten state parameters values that define a forecasted state resulting from the execution of action 0 0 0 0, in a state achieved as a result of all previous actions performed. Thereafter, the Recognizer reads the last nine achieved states and actions, action 0 0 0 0, the forecasted state, as well as action 0 0 0 1 in order to forecast a second intermediate state. The same process is applied to forecast a final state that would be achieved after action 1 0 0 0 has been performed.

Once all intermediate and final states of a scenario have been forecasted, they are individually evaluated 363, and attributed a desirability value of actions.

Referring back to FIG. 11, sequence 0 0 0 0 3 5 2 4 7 5 1 0 1 1 0 0 0 1 3 4 2 4 7 5 0 1 1 1 1 0 0 0 3 4 2 4 7 5 0 1 1 1 is sent to the Calculator 151. The latter assigns to each action a LDV corresponding to the number of squares separating the Character 503 from the goal. In the case of action 0 0 0 0, the Character 503 is expected to be at coordinates (3, 5), four squares away from the final destination, located at coordinates (6, 3). Similarly, for actions 0 0 0 1 and 1 0 0 0, the Character 503 is expected to be three and four squares away respectively. As a result, the Calculator 151 outputs sequence 0 0 0 0 3 5 2 4 7 5 1 01 1 4 0 0 0 1 3 4 2 4 7 5 0 1 1 1 3 1 0 0 0 3 4 2 4 7 5 0 1 1 1 4.

Thereafter, the scenario is evaluated by having its GDV calculated from the LDVs of its actions 365, and stored 367 in the Store 119. In the case illustrated in FIG. 10, the sequence generated by the Calculator 151 is sent to Calculator 155, attributed a GDV of 3.8 according to the following calculation (3*10+4*9+4*8)/(10+9+8)=3.38, and stored in the Store 119.

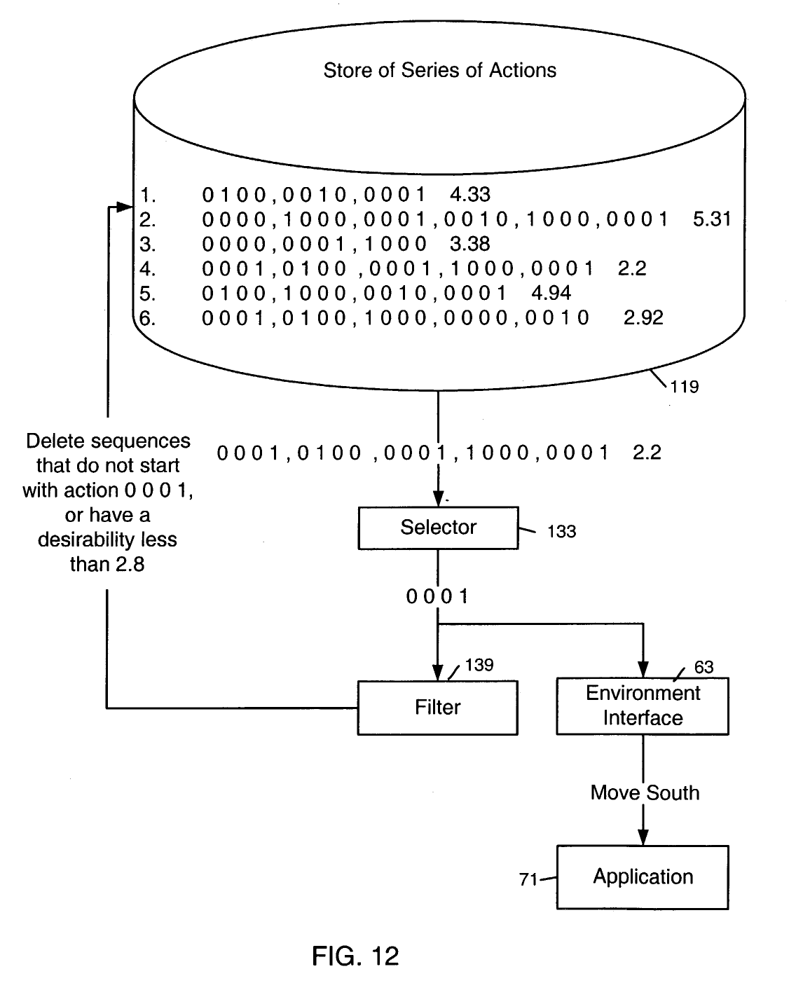

Steps 361 through 367 are repeated until a change in the evaluation function, or the end of a frame is detected. If a change in the evaluation function is detected, the Engine 45 returns to step 357 and resets the Timer 107. If, on the other hand, the end of a frame is reached, a best scenario is identified among those evaluated 373 by searching through the Store 119, and the Character 503 is instructed to perform its first scheduled action. In the case illustrated in FIG. 12, the fourth scenario of the Store 119 is the most desirable, with a GDV of 2.2. As a result, the Selector 133 sends action 0 0 0 1 to the Interface 63, which in turn, will instruct the Character 503 to move south.

The very same action is used to filter the content of the Store 119, as all scenarios starting with a different action are deleted 377. In the example illustrated in FIG. 12, the Filter 139 deletes all scenarios that do not start with action 0 0 0 1, namely, scenario 1, 3, 4, and 5. Of the remaining scenarios, those having a fitness level lower than a pre-determined threshold are deleted 379. In a preferred embodiment for this application, the threshold T is calculated according to T=ΣALDV(α)*1/5 where α is an integer ranging from 1 to 5, and ALDV(n) is the average of all possible LDVs that could be attributed to a state that would result from an execution of a nth action of a scenario that starts with the selected action. In the case illustrated in FIG. 12, the Filter 139 deletes scenario 6, for having a GDV higher than T=(4+3+3+2+2)/5=2.8. The last filtering step 381 consists in removing the first letter of each scenario, and evaluating the beheaded scenarios according to the newly detected state values.

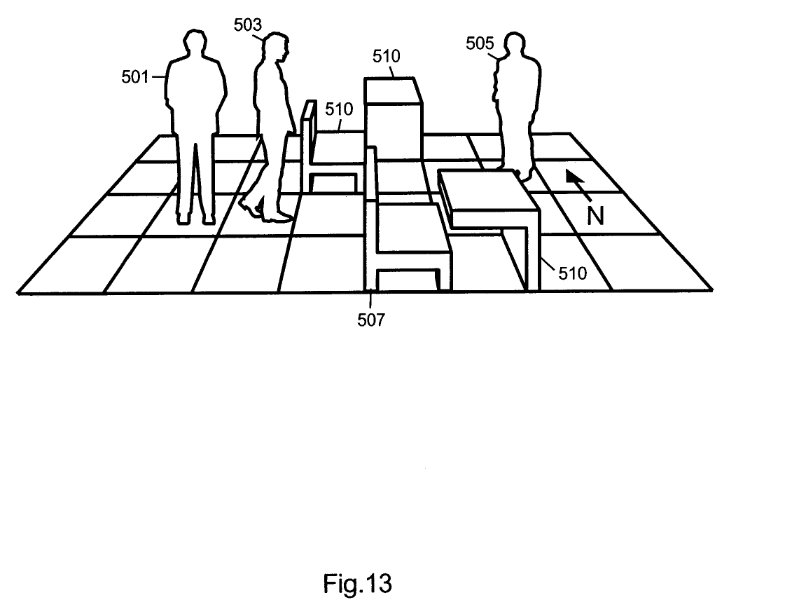

Once the action is performed, the Engine 45 verifies whether the goal has been achieved according to current state parameter values. If the goal has indeed been achieved, the user may enter a new goal 353 or deactivate the Engine 45, 387. If however, the goal has not been achieved, the step 257 is performed, which marks the start of a new iteration. FIG. 13 illustrates the new state of the Environment 43, resulting from having the Character 503 move south. The goal has not been achieved as the Character 503 is still three squares away from his destination; the Timer 107 will have to be reset for a new iteration.

The following description refers to a specific application of the present invention for opening a safe protected by a code consisting of a sequence of letters ranging from A to Z. The safe converts each entry into a number, according to a function selected from a set. In order to open the safe, a user must enter a sequence of letters, or safe code that corresponds to a count from 1 to an unknown number inferior or equal to 20. In order to increase the level of protection provided, the safe randomly alternates between functions available in the set and comprises an output indicating which function of the set is currently active.

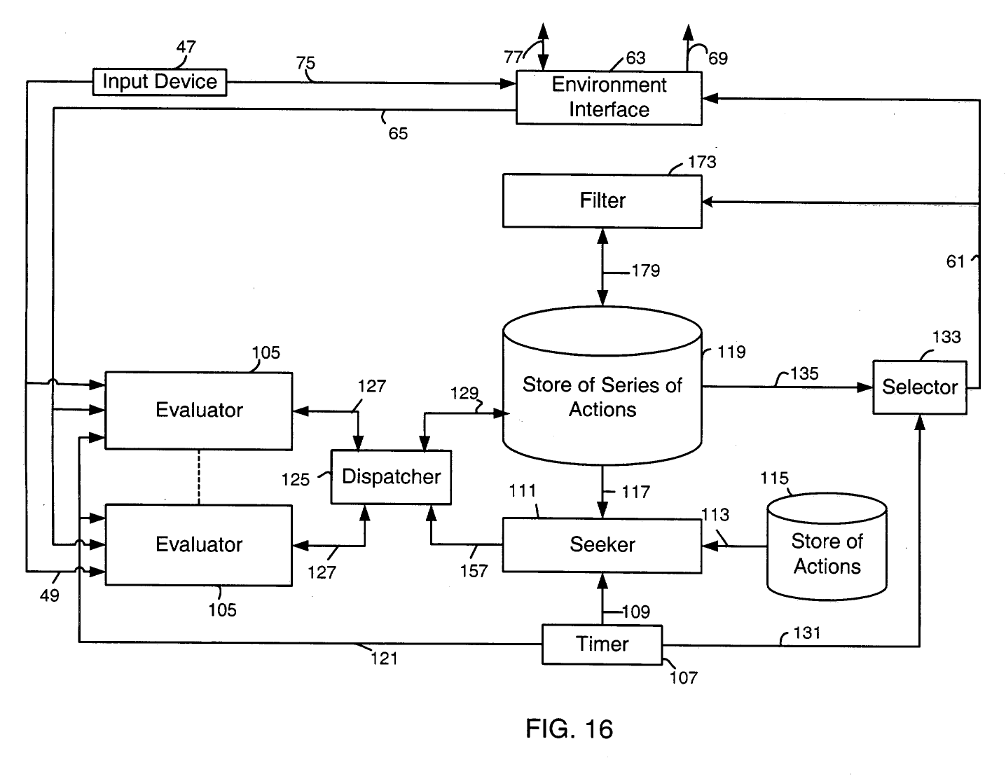

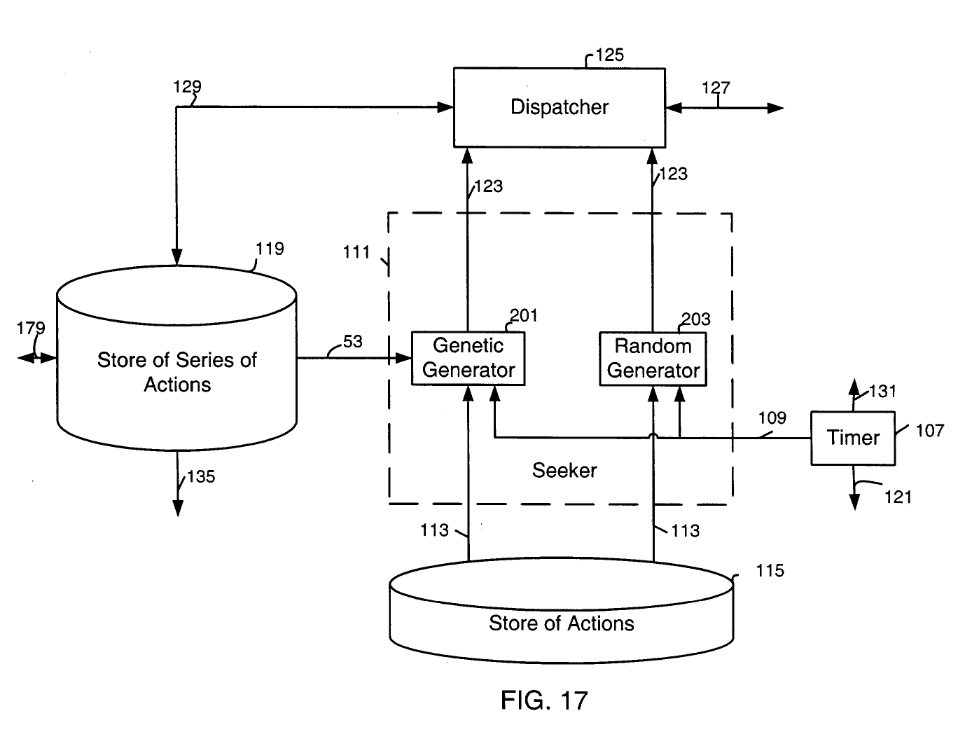

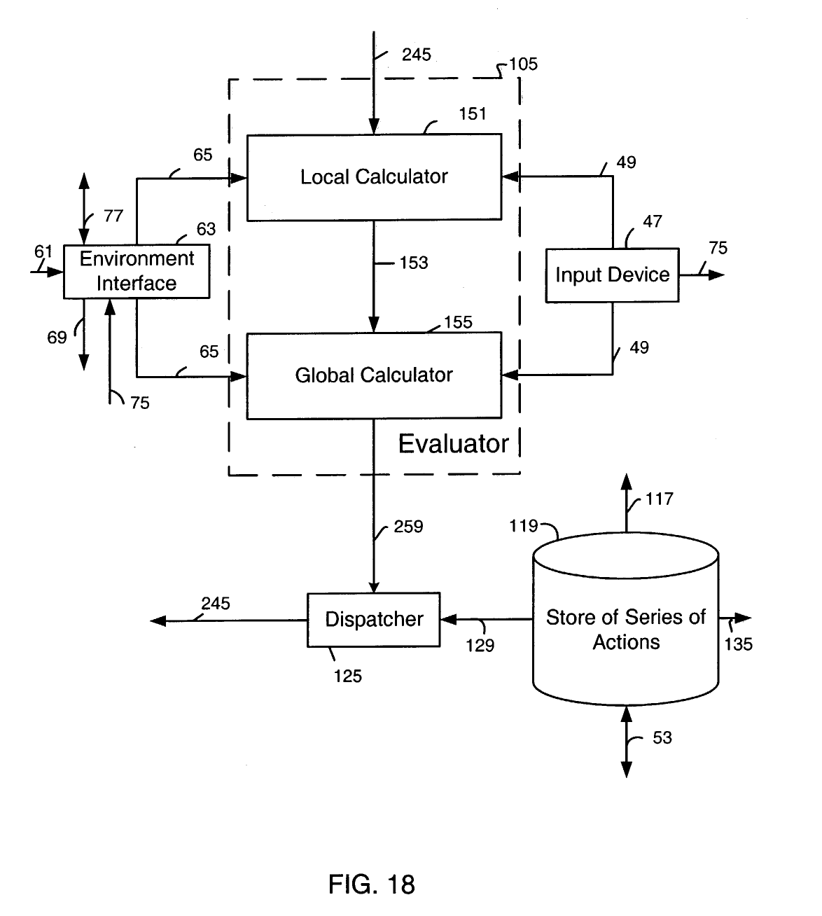

Referring to FIG. 16, in one embodiment of the present invention for this specific application, the Store 115 includes all letters ranging from A to Z, the Store 119 is capable of holding up to 100 sequences of letters, or codes, each code comprising 20 letters or less, the Seeker 111 is capable of generating 100 000 codes per second, the Evaluators 105 are capable of evaluating 100 000 codes per second, the Input Device 47 holds a set of functions, and is capable of retrieving a subset corresponding to a safe ID entered by a user, and the Sensors 77 are connected to the output of the safe. Referring now to FIG. 18, each Evaluator 105 comprises the Calculators 151 and 155 described herein above. For this specific application, the Calculator 151 applies an active function to each letter of a sequence, and determines whether the resulting number corresponds to the one found at the same position in the count. It is important to note that the evaluation is performed according to an active function from the set, which is determined by the Calculator 151 according to data provided by the Sensors 77. A letter is attributed an LDV of 1 if it does, and 0 otherwise. Once all LDVs of a code have been assigned, they are sent to the Calculator 155, which calculates their weighted average, or GDV, wherein a position j of the code is associated with a weight W(j)=2^{19-j}. In this particular case, the higher the GDV, the higher the fitness level of the corresponding code.

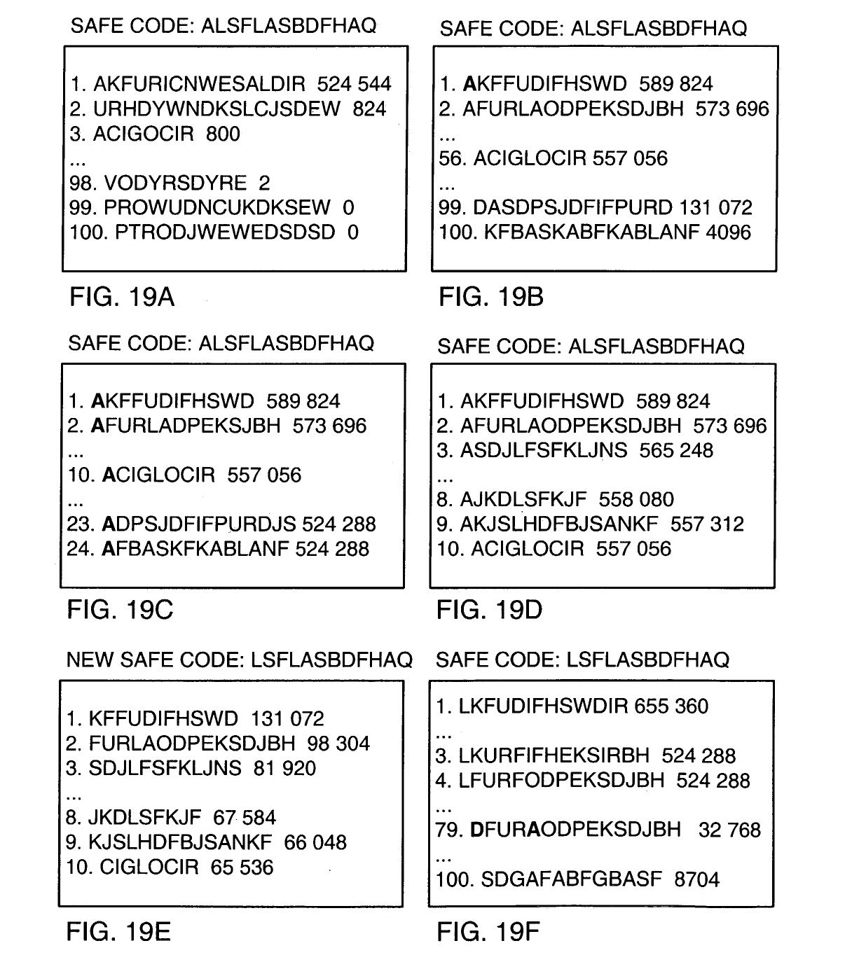

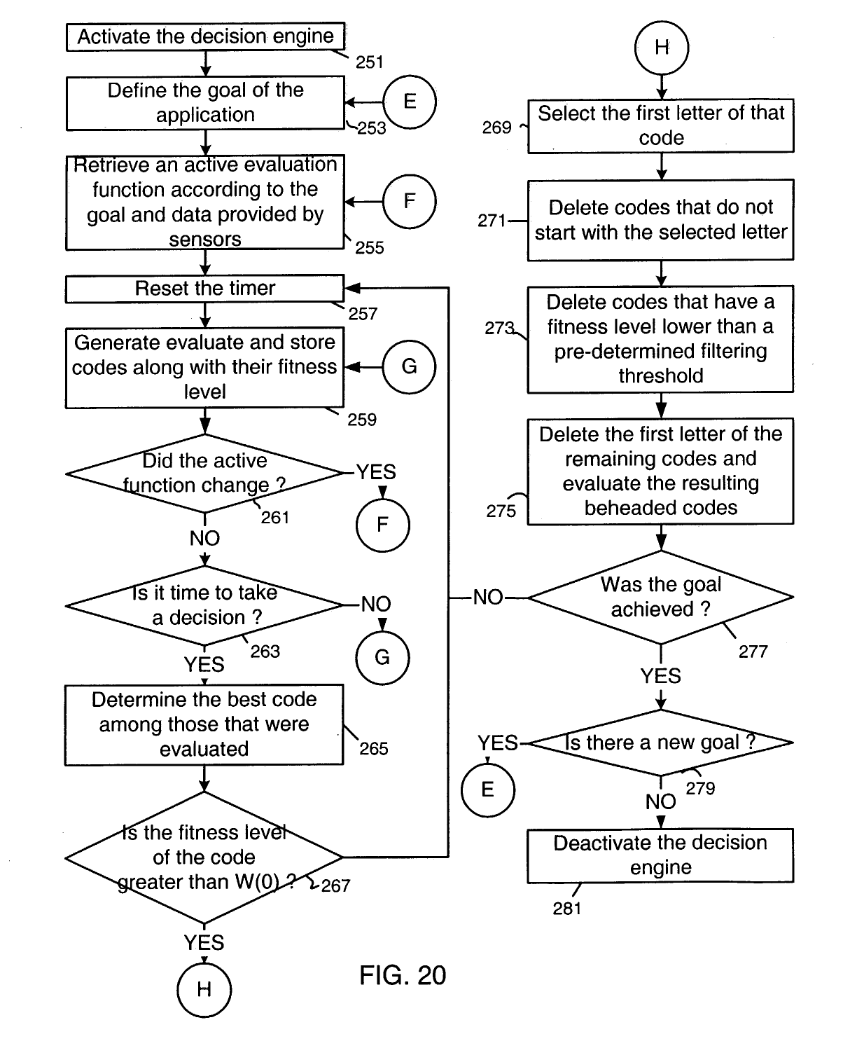

Referring to FIGS. 19 and 20, there are shown diagrams illustrating the evolution of a content of the Store 119 during the letter-selection process, and a flow chart describing the process itself. The latter can be broken into two sub-processes, the first of which, serves the purpose of initializing the engine. This is done by having the user activate the engine 251, and define its goal 253: opening a safe corresponding to ID 164. The last step of the initialization sub-process consists in having the engine retrieve an active evaluation function 255 corresponding to the given safe ID, and a state of the safe provided through the sensors.

The second sub-process is iterative, lasts 1 second, and is executed until the safe code has been correctly identified. Its first step consists in having the engine generate, evaluate, and store 100 000 random codes 257 in the Store 119 along with their score. FIG. 19A provides a view of the content of the Store 119 during an execution of step 257: a plurality of codes stored according to and along with their scores. Of the 100 000 codes generated, the 99 900 least fit are discarded due to the limited capacity of the Store of Series of Actions.

Every time the active function changes, the engine returns to step 255 and resets the Timer 127. Once the end of a time frame is indicated by the Timer 127, the engine identifies a best code among those that were evaluated 263, and verifies whether it has a value equal or superior to W(0), in which case the engine selects its first letter 267. However, if the value of the code is lower than W(0), no letter is selected, and the engine returns to step 257. In a case illustrated in FIG. 19B, code AKFUDIFHSWD boasted a highest score with 589 824, which is greater than W(0)=524 288, and the active function did not change; as a result, the engine found a first letter of the safe code, A.

The very same letter is used to filter a content of the Store 119 as the engine deletes all codes that start with a different letter 269. The resulting content is shown in FIG. 19C: 24 codes starting with letter A. Of the remaining codes, those having scores lower than a pre-determined threshold are deleted 271. In a preferred embodiment for this application, the threshold T is calculated according to T=W(0)+Σ(W(b)*1/26) where b is an integer ranging from 1 to the smallest of an average length of codes and a length of the remaining solution code, minus 1. This step is shown FIG. 8D, where 14 of the 24 remaining codes have been eliminated for having scores lower than T=544 137.8.

The last filtering step consists in removing the first letter of each code, and evaluating the beheaded codes according to the remaining solution code 273. The content of the filtered Store 119 is shown in FIG. 19E, holding 10 codes corresponding to ones shown in FIG. 19D, after they have been stripped from their first letter, and evaluated according to the remainder of the solution code LSFLASBDFHAQ. For instance, code ASDJLFSFKLJNS from FIG. 19D, was stripped from its first letter, A, and the resulting code SDJLFSFKLJNS was attributed a score of 21 920.

Thereafter, step 257 is performed, which marks the start of a new iteration. Although some of the codes are generated randomly in order to explore new venues, most of them stem from the application of genetic operators. The resulting content of Store 119 shown in FIG. 19F, depicts the deployment of two code-generation techniques: the 79th code was obtained by mutating the first and fifth letter of the 4^{th} code, and the 3^{rd} one, by cross-breeding the 1^{st} and the 4^{th}.

In the preferred embodiment of the invention, for this specific application, deletions are not used in the code-generation process, as they would offset all letters of a target code that follow the deleted ones, including those that were attributed a LDV of 1. In addition, a letter is assigned a mutation rate of 0% if its LDV is equal to 1, and 100% if it is the first letter of its code and has a LDV of 0. As for the others, the further they are in the code, the lower their mutation rate.

If the destination is yet to be reached, the Engine 45 returns to step 357 in order to reset the Timer 107 for a new iteration. If, however, the final destination is reached, the user is prompted to define a new goal, in which case the Engine 45 returns to step 355. If, however, the user does not wish to define a new goal, the Engine 45 is deactivated 381.

Although the present invention has been described as combining variants of genetic algorithms and neural networks, it can be empowered by any functional combination of problem-solving and forecasting algorithms.

Although the present invention has been described as operating independently, it can be easily modified to collaborate with other algorithms in achieving its goal.

The present invention can be easily adapted to various timing requirements by modifying settings of the Timer 107. For instance, when the present invention is assigned to larger solution spaces, the user can lengthen the time frame, thereby allowing the Engine 45 to explore more options prior to taking a decision. In the preferred embodiment, a length of the time frame is determined by the Timer 107 at the beginning of each iteration according to state values and a defined goal.

Although the present invention has been described as controlling a single application, it can be easily extended to simultaneously handle various applications operating in various environments, by specifying the target application for each action in a series.

While the invention has been described in connection with specific embodiments thereof, it will be understood that it is capable of further modifications and this application is intended to cover any variations, uses, or adaptations of the invention following, in general, the principles of the invention and including such departures from the present disclosure as come within known or customary practice within the art to which the invention pertains and as may be applied to the essential features hereinbefore set forth, and as follows in the scope of the appended claim.

What is claimed is:

1. An apparatus for selecting actions in an environment, comprising:
a first store comprising a plurality of proposed series of actions;
an environment interface providing at least one action to an environment and detecting at least one state value from said environment resulting, at least in part, from said action provided;
an evaluation module calculating a global desirability value for an unvalued series of actions of said plurality according to said state value and storing said desirability value in said store; and
a selection module for selecting one of said plurality according to said desirability value, and providing at least a first action of the selected series to said environment interface.

2. The apparatus of claim 1, further comprising one forecasting module for forecasting at least one state value that would be detected from said environment between a first moment at which a first action of said unvalued series would be provided to said environment and a second moment at which a last action of said unvalued series would be provided to said environment if each action of said unvalued series is provided to said environment, wherein said evaluation module calculates a global desirability value for said unvalued series according to said state value forecasted and stores said desirability value in said store.

3. The apparatus of claim 1, further comprising a filter module deleting each one of said plurality of proposed series of actions that does not start with said at least one action, and removing at least a first action of proposed series of actions remaining in said store to provide a filtered plurality of proposed series of actions.

4. The apparatus of claim 1, wherein said filter module deletes each one of said plurality of proposed series of actions that do not start with said at least one action, deletes each one of said plurality of proposed series of actions having a global desirability value lower than a filtering threshold, and removes at least a first action of proposed series of actions remaining in said store to provide a filtered plurality of proposed series of actions.

5. The apparatus of claim 4, wherein said filter module further comprises a threshold calculator for calculating said filtering threshold.

6. The apparatus of claim 2, further comprising a search module for generating a new plurality of proposed series of actions, and storing said new plurality in said store.

7. The apparatus of claim 3, further comprising a search module for generating a new plurality of proposed series of actions, and storing said new plurality in said store.

8. The apparatus of claim 6, wherein said search module comprises a genetic module for generating at least one of said new plurality by applying a genetic operator on one of said plurality of proposed series of actions.

9. The apparatus of claim 7, wherein said search module comprises a genetic module for generating at least one of said new plurality by applying a genetic operator on one of said plurality of proposed series of actions.

10. The apparatus of claim 2, further comprising an input module for detecting an instruction, determining an evaluation parameter value according to said instruction, and setting said parameter value, wherein said evaluation module calculates said desirability value according to said parameter value.

11. The apparatus of claim 3, further comprising an input module for detecting an instruction, determining an evaluation parameter value according to said instruction, and setting said parameter value, wherein said evaluation module calculates said desirability value according to said parameter value.

12. The apparatus of claim 8, further comprising a third store comprising a series of previously selected actions and a series of previously detected state values, wherein said genetic module generates at least one of said new plurality by applying a genetic operation on a series of actions extracted from said series of previously selected actions.

13. The apparatus of claim 9, further comprising a third store comprising a series of previously selected actions and a series of previously detected state values, wherein said genetic module generates at least one of said new plurality by applying a genetic operation on a series of actions extracted from said series of previously selected actions.

14. The apparatus of claim 2, further comprising a fourth store comprising a plurality of patterns, wherein said forecasting module forecasts said at least one state value that would be detected from said environment according to one of said plurality of patterns.

15. The apparatus of claim 12, further comprising a fourth store comprising a plurality of patterns, wherein said forecasting module forecasts said at least one state value that would be detected from said environment according to one of said plurality of patterns.

16. The apparatus of claim 10, further comprising a fourth store comprising a plurality of patterns associated with a plurality of environments, wherein said input module determines said environment according to said instruction, said plurality of environments comprises said environment, and said forecasting module forecasts said at least one state value according to one of said plurality of patterns associated with said environment, whereby said forecasting module is capable of adjusting its functionality according to said environment.

17. The apparatus of claim 15, wherein said forecasting module further comprises a pattern-recognizer for identifying at least one pattern in said series of previously selected actions and said series of previously detected state values, and storing said pattern in said fourth store.

18. The apparatus of claim 6, further comprising a store of rules comprising a set of requirements to be satisfied by said new plurality, wherein said search module generates said new plurality according to said requirements, whereby said new plurality is more likely to have a higher desirability.

19. The apparatus of claim 2, wherein said at least one evaluation module comprises a local calculator for calculating local desirability values for actions comprised in said unvalued series of actions according to said at least one state value forecasted, and a global calculator for calculating a global desirability value from said local desirability values.

20. A computer program product for selecting actions in an environment comprising a computer usable storage medium having computer readable program code means embodied in the medium, the computer readable program code means comprising:
storage means for providing a plurality of proposed series of actions;
interfacing means for providing at least one action to the environment and detecting at least one state value from said environment resulting, at least in part, from said action provided;
evaluation means for calculating a global desirability value for an unvalued series of actions of said plurality according to said state value and providing said desirability value; and
selection means for selecting one of said plurality according to said global desirability value, and identifying at least a first action of the selected series of actions as said at least one action.
